(19) United States
(12) Patent Application Publication
(10) Pub. No.: US 2025/0048127 A1
(43) Pub. Date: Feb. 6, 2025

(54) ELECTRONIC DEVICE, WIRELESS COMMUNICATION METHOD, AND COMPUTER-READABLE STORAGE MEDIUM

(71) Applicant: Sony Group Corporation, Tokyo (JP)

(72) Inventors: Wei XU, Nanjing, Jiangsu (CN); Yuwei GAO, Nanjing, Jiangsu (CN); Tingting FAN, Beijing (CN); Chen SUN, Beijing (CN)

(73) Assignee: Sony Group Corporation, Tokyo (JP)

(21) Appl. No.: 18/716,960

(22) PCT Filed: Jan. 5, 2023
(86) PCT No.: PCT/CN2023/070576

§ 371 Date: Jun. 6, 2024

(30) Foreign Application Priority Data
Jan. 12, 2022 (CN) 202210031574.X

(51) Int. Cl. H04W 16/28; H04B 7/04; H04W 24/10

(52) U.S. Cl. CPC H04W 16/28; H04B 7/04013; H04W 24/10

(57) ABSTRACT

An electronic device includes a processing circuit configured to: measure the channel quality of multiple beams of a mobile large intelligent surface (LIS) and the channel quality of multiple beams of one or more candidate fixed LISs; and determine a fixed LIS, a service beam of the fixed LIS, and a service beam of the mobile LIS according to a measurement result, so as to provide service for the electronic device by the service beam of the fixed LIS and the service beam of the mobile LIS. According to the electronic device, the wireless communication method, and the computer-readable storage medium of the present disclosure, the advantages of the fixed LIS and the mobile LIS can be combined, and the fixed LIS and the mobile LIS can jointly provide service for a user equipment, so as to improve the communication quality of the user equipment.

This application claims the priority of Chinese Patent Application No. 202210031574.X, entitled “ELECTRONIC DEVICE, WIRELESS COMMUNICATION METHOD, AND COMPUTER-READABLE STORAGE MEDIUM”, filed with the Chinese Patent Office on Jan. 12, 2022, the entire contents of which are incorporated herein by reference.

### FIELD

The present disclosure relates to the technical field of wireless communications, particularly to an electronic apparatus, a wireless communication method, and a computer-readable storage medium. More particularly, the present disclosure relates to an electronic apparatus as a network side equipment in a wireless communication system, an electronic apparatus as user equipment in a wireless communication system, a wireless communication method performed by a network side equipment in a wireless communication system, a wireless communication method performed by user equipment in a wireless communication system, and a computer-readable storage medium.

### BACKGROUND

In recent years, the capacity of communication networks has been increasing. However, highly complex networks, high-cost hardware and increasing energy consumption have become key problems faced by wireless communications in the future. Large intelligent surfaces (LIS) have characteristics of low cost, low energy consumption, programmability and prone to be deployment. The LIS can intelligently reconfigure a wireless propagation environment by integrating a large number of low-cost passive reflective components on a plane. On the one hand, a multiplexing gain of a wireless communication system can be improved using the LIS. On the other hand, control of propagation directions of signals and in-phase superposition of the signals can be realized in a three-dimensional space using the LIS, which increases strength of the received signal, thereby improving performance of transmission between communication apparatuses. Therefore, the LIS has great potential in terms of enhancing coverage and capacity of future wireless networks, providing virtual line of sight links, eliminating some coverage blind regions, serving cell edge users, and solving inter cell co-frequency interference.

The LIS may be installed on a surface of a fixed object such as a building, but the number of user equipment (UE) that can be served by the LIS is limited. The LIS may also be installed on a mobile object such as an unmanned aerial vehicle (UAV), but it is required to adjust an angle of an antenna of a base station to cover the UAV.

The present disclosure expects to provide a technical solution to combine advantages of the fixed LIS and the mobile LIS, so that the fixed LIS and the mobile LIS jointly serve the user equipment, thereby improving the communication quality of the user equipment.

### SUMMARY

A summary of the present disclosure is provided in this section, which is not a comprehensive disclosure of the full scope or all features of the present disclosure.

An object of the present disclosure is to provide an electronic apparatus, a wireless communication method, and a computer-readable storage medium, to combine advantages of the fixed LIS and the mobile LIS, so that the fixed LIS and the mobile LIS jointly serve the user equipment, thereby improving the communication quality of the user equipment.

According to an aspect of the present disclosure, an electronic apparatus is provided. The electronic apparatus includes processing circuitry configured to: measure channel quality of multiple beams of a mobile Large Intelligent Surface LIS and multiple beams of one or more candidate fixed LISs; and determine a fixed LIS, a serving beam of the fixed LIS, and a serving beam of the mobile LIS according to measurement results, to serve the electronic apparatus by the serving beam of the fixed LIS and the serving beam of the mobile LIS.

According to another aspect of the present disclosure, an electronic apparatus is provided. The electronic apparatus includes processing circuitry configured to: configure a reference signal, a position and a direction of a mobile Large Intelligent Surface LIS, and directions of one or more candidate fixed LISs, so that user equipment measures channel quality of multiple beams of the mobile LIS and multiple beams of the one or more candidate fixed LISs, and determines a fixed LIS, a serving beam of the fixed LIS, and a serving beam of the mobile LIS according to measurement results; receive, from the user equipment, information on the fixed LIS, the serving beam of the fixed LIS, and the serving beam of the mobile LIS which are determined; and configure a direction of the mobile LIS and a direction of the fixed LIS, so that the user equipment is served by the serving beam of the fixed LIS and the serving beam of the mobile LIS.

According to another aspect of the present disclosure, a wireless communication method performed by an electronic apparatus is provided. The method includes: measuring channel quality of multiple beams of a mobile Large Intelligent Surface LIS and multiple beams of one or more candidate fixed LISs; and determining a fixed LIS, a serving beam of the fixed LIS, and a serving beam of the mobile LIS according to measurement results, to serve the electronic apparatus by the serving beam of the fixed LIS and the serving beam of the mobile LIS.

According to another aspect of the present disclosure, a wireless communication method performed by an electronic apparatus is provided. The method includes: configuring a reference signal, a position and a direction of a mobile Large Intelligent Surface LIS, and directions of one or more candidate fixed LISs, so that user equipment measures the channel quality of multiple beams of the mobile LIS and multiple beams of the one or more candidate fixed LISs, and determines a fixed LIS, a serving beam of the fixed LIS, and a serving beam of the mobile LIS according to measurement results; receiving, from the user equipment, information on the fixed LIS, the serving beam of the fixed LIS, and the serving beam of the mobile LIS which are determined; and configuring a direction of the mobile LIS and a direction of the fixed LIS, so that the user equipment is served by the serving beam of the fixed LIS and the serving beam of the mobile LIS.

According to another aspect of the present disclosure, a computer-readable storage medium is provided. The computer-readable storage medium includes executable computer instructions that, when executed by a computer, cause the computer to perform the wireless communication method according to the present disclosure.

According to another aspect of the present disclosure, a computer program is provided. The computer program, when executed by a computer, causes the computer to perform the wireless communication method according to the present disclosure.

With the electronic apparatus, the wireless communication method and the computer-readable storage medium according to the present disclosure, the electronic apparatus as a network side equipment can configure the reference signal, the position and the direction of the mobile LIS, and the direction of the fixed LIS, so that the electronic apparatus as user equipment can select the fixed LIS, the serving beam of the fixed LIS, and the serving beam of the mobile LIS according to the channel quality of beams of the mobile LIS and beams of the fixed LIS. The fixed LIS and the mobile LIS jointly serve the user equipment. In this way, the advantages of the fixed LIS and the mobile LIS are combined, thereby improving the communication quality of the user equipment.

Further areas of capability will become apparent from the description provided herein. The description and specific examples in the summary are only illustrative and are not intended to limit the scope of the present disclosure.

### BRIEF DESCRIPTION OF THE DRAWINGS

The drawings described herein are for illustrating selected embodiments only rather than all possible implementations, and are not intended to limit the scope of the present disclosure. In the drawings:

FIG. 1 is a schematic diagram showing a scenario in which a fixed LIS serves UE;

FIG. 2 is a schematic diagram showing a scenario in which a mobile LIS serves UE;

FIG. 3 is a schematic diagram showing a scenario in which an angle of an antenna is required to be changed in a case that the mobile LIS serves the UE;

FIG. 4 is a schematic diagram showing a scenario in which a gNB is placed on an unmanned aerial vehicle to serve the UE;

FIG. 5 is a schematic diagram showing a scenario in which signal quality is poor due to the UE being blocked;

FIG. 6 is a block diagram showing an example of configuration of an electronic apparatus according to an embodiment of the present disclosure;

FIG. 7 is a schematic diagram showing a scenario in which the fixed LIS and the mobile LIS serve the UE according to an embodiment of the present disclosure;

FIG. 8 is a schematic diagram showing a process of determining candidate fixed LISs according to an embodiment of the present disclosure;

FIG. 9 is a schematic diagram showing a candidate region of a mobile LIS according to an embodiment of the present disclosure;

FIG. 10(a) and FIG. 10(b) each are a schematic diagram showing a process of two fixed LISs performing wide beam scanning simultaneously according to an embodiment of the present disclosure;

FIG. 11(a) to FIG. 11(d) each are a schematic diagram showing a process of two fixed LISs performing wide beam scanning at different times according to an embodiment of the present disclosure;

FIG. 12(a) to FIG. 12(c) each are a schematic diagram showing a process of the fixed LIS and the mobile LIS performing narrow beam scanning according to an embodiment of the present disclosure;

FIG. 13 is a schematic diagram showing determination of the number of times of scanning of a serving beam of the fixed LIS and the number of times of scanning of a serving beam of the mobile LIS according to an embodiment of the present disclosure;

FIG. 14 is a schematic diagram showing a scenario in which channel quality of all currently available beams of the UE is very poor according to an embodiment of the present disclosure;

FIG. 15 is a block diagram showing an example of configuration of an electronic apparatus according to another embodiment of the present disclosure;

FIG. 16 is a schematic diagram showing a process of determining a candidate region of a mobile LIS according to an embodiment of the present disclosure;

FIG. 17 is a flowchart showing signaling of a process of determining a serving beam of the fixed LIS and a serving beam of the mobile LIS according to an embodiment of the present disclosure;

FIG. 18 is a flowchart of a wireless communication method performed by an electronic apparatus according to an embodiment of the present disclosure;

FIG. 19 is a flowchart of a wireless communication method performed by an electronic apparatus according to another embodiment of the present disclosure;

FIG. 20 is a block diagram showing a first example of a schematic configuration of a gNB;

FIG. 21 is a block diagram showing a second example of a schematic configuration of the gNB;

FIG. 22 is a block diagram showing an example of a schematic configuration of a smartphone; and

FIG. 23 is a block diagram showing an example of a schematic configuration of a car navigation device.

Although various modifications and alternations are easily made to the present disclosure, specific embodiments of the present disclosure are shown in the drawings by examples, and are described in detail herein. It should be understood that description for the specific embodiments herein is not intended to limit the present disclosure to the specific form as disclosed. Instead, the present disclosure aims to cover all modifications, equivalents and alternations within the spirit and scope of the present disclosure. It is noted that throughout the drawings, corresponding reference numerals indicate corresponding parts.

### DETAILED DESCRIPTION OF EMBODIMENTS

Examples of the present disclosure are fully disclosed with reference to the drawings. The following description is merely illustrative and is not intended to limit the present disclosure and applications or usage thereof.

Exemplary embodiments are provided so that the present disclosure becomes thorough and the scope thereof is fully conveyed to those skilled in the art. Numerous specific details such as examples of specific components, devices and methods are set forth to provide a thorough understanding of embodiments of the present disclosure. It is apparent for those skilled in the art that, exemplary embodiments may be implemented in various ways without these specific details, which should not be constructed as limiting the scope of the present disclosure. In some exemplary embodiments, well-known processes, structures and technologies are not described in detail.

Description is made in the following order:
1. Description of Scenario;
2. Configuration Examples of User Equipment;
3. Configuration Examples of Network side equipment;
4. Method Embodiments; and
5. Application Examples.

### <1. Description of Scenario>

FIG. 1 is a schematic diagram showing a scenario in which a fixed LIS serves UE. As shown in FIG. 1, the fixed LIS is installed on a surface of a building and can serve the user equipment under control of a gNB. However, from the perspective of deployment, finding a position for installing the fixed LIS involves problems such as a site rent, an impact on a urban landscape, and whether an owner agrees to install the LIS. From the perspective of performance, the LIS deployed on the surface of the building can only serve users in half of the space. That is, a source node and a destination node are required to be on a same side of the building. Therefore, there are some limitations in serving the user equipment by the fixed LIS.

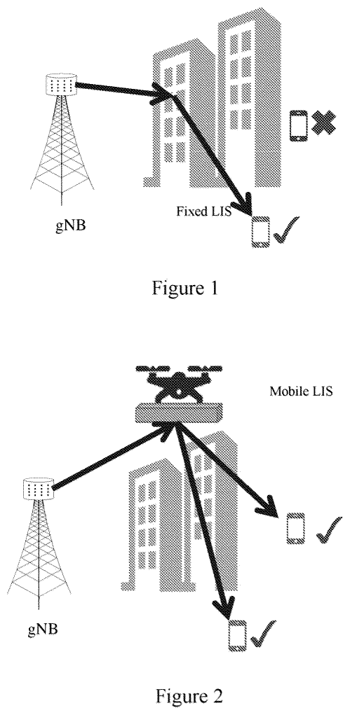

FIG. 2 is a schematic diagram showing a scenario in which a mobile LIS serves UE. As shown in FIG. 2, the mobile LIS is installed on a UAV. Compared with the limitations of the fixed LIS, the mobile LIS has no restrictions on a position relationship between the source node and the destination node, so that the mobile LIS can serve more user equipment.

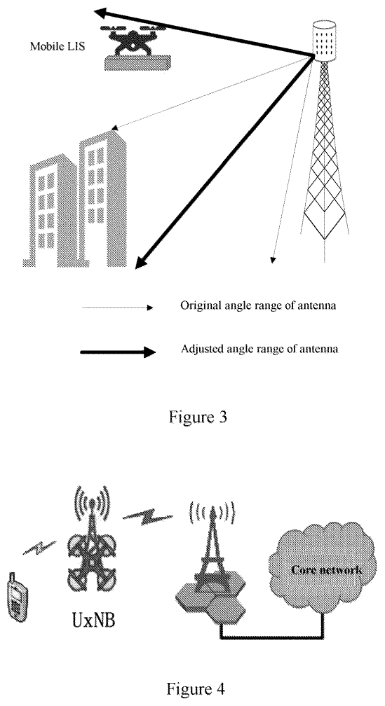

FIG. 3 is a schematic diagram showing a scenario in which an angle of an antenna is required to be changed in a case that the mobile LIS serves the UE. In an existing cellular communication system, an antenna of a base station equipment is installed on a high-rise cellular tower and tilted slightly downward, because most user equipment is either on the ground or in buildings. Therefore, in a case that the mobile LIS is installed on the UAV, the angle of the antenna is required to be adjusted to cause a signal from the base station equipment to reach the UAV. As shown in FIG. 3, the adjustment of the angle of the antenna reduces coverage on the ground.

FIG. 4 is a schematic diagram showing a scenario in which a gNB is placed on an unmanned aerial vehicle to serve the UE. In order to improve the communication quality of users, a base station equipment may also be placed on the unmanned aerial vehicle, that is, an airborne wireless access node (UxNB). The UxNB can be connected to a core network through a wireless link and function as a base station. In addition, the UxNB can serve as a base station or a relay. The base station equipment such as the gNB is placed on the unmanned aerial vehicle, so that the UxNB has high power consumption and high complexity.

It can be seen that there are some limitations in serving the user equipment by the fixed LIS. The angle of the antenna of the base station equipment is required to be changed in a case that the user equipment is served by the mobile LIS, and placing the base station equipment on the unmanned aerial vehicle results in too high power consumption and complexity. Therefore, the present disclosure expects to provide an electronic apparatus in a wireless communication system, a wireless communication method performed by the electronic apparatus in the wireless communication system, and a computer-readable storage medium, to combine the advantages of the fixed LIS and the mobile LIS, so that the fixed LIS and the mobile LIS jointly serve the user equipment, thereby improving the communication quality of the user equipment.

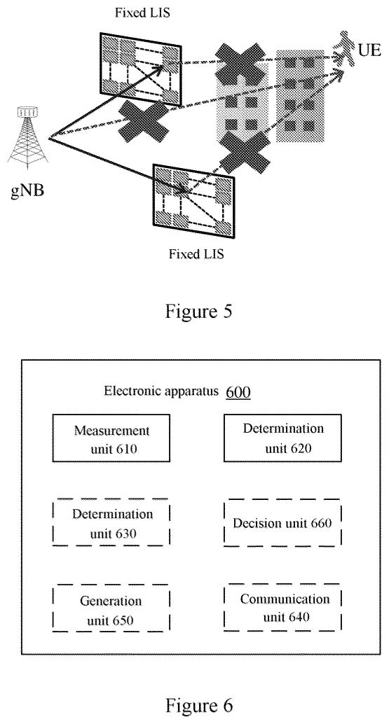

FIG. 5 is a schematic diagram showing a scenario in which signal quality is poor due to the UE being blocked. As shown in FIG. 5, the UE is blocked by a building or other obstacle, and the gNB cannot communicate with the UE through a direct path. In addition, two fixed LISs have been deployed in a cell, and the gNB cannot communicate with the UE through the two fixed LISs. In this case, all paths between the gNB and the UE are unavailable, resulting in poor communication quality of the UE.

The problem of poor communication quality of the UE caused by such scenario can be solved with the technical solution provided according to the present disclosure. It should be noted that the technical solution according to the present disclosure is not limited to such scenarios, and the present disclosure is applicable to all scenarios in which the communication quality of UE is required to be improved.

The wireless communication system according to the present disclosure may be a 5G NR communication system or a 6G or higher-level communication system.

The network side equipment according to the present disclosure may be a base station equipment, for example, an eNB, or a gNB (a base station in a fifth generation communication system).

The user equipment according to the present disclosure may be a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). In addition, the user equipment may be a wireless communication module (such as an integrated circuit module including a single wafer) installed on each of the terminals described above.

In the present disclosure, the fixed LIS refers to an LIS installed on a fixed object such as a building, and the mobile LIS refers to an LIS installed on a mobile object such as a an unmanned aerial vehicle, a fire balloon, a car, and a train.

The embodiments of the present disclosure are mainly applicable to downlink transmission. In other words, the fixed LIS and the mobile LIS are used to provide downlink transmission services for the user equipment. That is, the base station equipment transmits downlink information to the user equipment through the fixed LIS and the mobile LIS.

### <2. Configuration Examples of User Equipment>

FIG. 6 is a block diagram showing an example of configuration of an electronic apparatus 600 according to an embodiment of the present disclosure. The electronic apparatus 600 here may serve as user equipment in a wireless communication system.

As shown in FIG. 6, the electronic apparatus 600 may include a measurement unit 610 and a determination unit 620.

Here, each unit of the electronic apparatus 600 may be included in a processing circuitry. It should be noted that the electronic apparatus 600 may include one processing circuitry or multiple processing circuits. Further, the processing circuitry may include various discrete functional units to perform different functions and/or operations. It should be noted that these functional units may be physical entities or logical entities, and units with different names may be implemented by a same physical entity.

According to the embodiments of the present disclosure, the measurement unit 610 measures channel quality of multiple beams of the mobile LIS and multiple beams of one or more candidate fixed LISs.

According to the embodiments of the present disclosure, the determination unit 620 determines the fixed LIS, a serving beam of the fixed LIS and a serving beam of the mobile LIS according to measurement results of the measurement unit 610, so that the serving beam of the fixed LIS and the serving beam of the mobile LIS serve the electronic apparatus 600.

It can be seen that the electronic apparatus 600 according to the embodiments of the present disclosure can select the fixed LIS, the serving beam of the fixed LIS and the serving beam of the mobile LIS according to the channel quality of the beams of the mobile LISs and the beams of the fixed LIS, and the fixed LIS and the mobile LIS jointly serve the electronic apparatus 600. In this way, the advantages of the fixed LIS and the mobile LIS are combined, thereby improving the communication quality of the electronic apparatus 600.

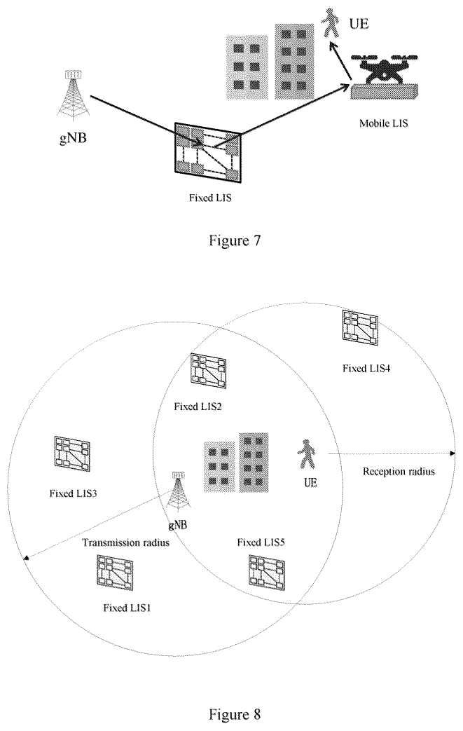

FIG. 7 is a schematic diagram showing a scenario in which a fixed LIS and a mobile LIS serve UE according to an embodiment of the present disclosure. In the scenario shown in FIG. 5, communication between the gNB and the UE cannot be realized neither through a direct path between the gNB and the UE nor through assistance of the fixed LIS. In FIG. 7, communication between the gNB and the UE can be realized with the assistance of the fixed LIS and the mobile LIS. In this way, the gNB is unnecessary to communicate with the mobile LIS directly, so that it is unnecessary to adjust the angle of the antenna of the gNB. Due to the assistance of the mobile LIS, the position relationship of the UE and the gNB is not limited to be arranged in a same side of the fixed LIS. In addition, the difficulty of installing the LIS on a mobile object is much lower than the difficulty of installing the gNB on a mobile object.

According to the embodiments of the present disclosure, as shown in FIG. 6, the electronic apparatus 600 may further include a determination unit 630 configured to determine one or more candidate fixed LISs.

According to the embodiments of the present disclosure, the determination unit 630 may determine one or more candidate fixed LISs according to positions of all fixed LIS within serving range of the base station equipment.

Here, the electronic apparatus 600 may acquire all fixed LIS around by D2D sensing. In addition, if the electronic apparatus 600 has accessed to a service cell of a base station equipment, the electronic apparatus 600 may also acquire information of all fixed LIS in the cell through cell public information.

According to the embodiments of the present disclosure, the determination unit 630 may determine a candidate region of a fixed LIS according to transmission range of the base station equipment and reception range of the electronic apparatus 600, and determine fixed LISs in the candidate region of the fixed LIS as the candidate fixed LISs.

Here, the determination unit 630 may determine the transmission range of the base station equipment according to a transmission power of the base station equipment. The transmission range of the base station equipment represents a region where a transmission signal from the base station equipment can be received. For example, the determination unit 630 may determine a transmission radius according to the transmission power of the base station equipment. The transmission range of the base station equipment is represented by a circle with a position of the base station equipment as a center and the transmission radius as a radius. In addition, the determination unit 630 may directly determine range of the cell served by the base station equipment as the transmission range of the base station equipment.

Further, the determination unit 630 may determine the reception range of the electronic apparatus 600 according to parameters such as ability of the electronic apparatus 600 to receive a signal. The reception range of the electronic apparatus 600 represents a region where the electronic apparatus 600 can receive a signal. For example, the determination unit 630 may determine the reception radius of the electronic apparatus 600 according to parameters such as the ability of the electronic apparatus 600 to receive a signal. The reception range of the electronic apparatus 600 is represented by a circle with the position of the electronic apparatus 600 as a center and the reception radius as a radius.

According to the embodiments of the present disclosure, the determination unit 630 may determine an overlapping region between the transmission range of the base station equipment and the reception range of the electronic apparatus 600 as the candidate region of the fixed LIS, and determine the fixed LIS in the candidate region of the fixed LIS as the candidate fixed LISs. That is, the candidate fixed LISs can receive the transmission signal from the base station equipment, and the transmission signal from the candidate fixed LISs can be received by the electronic apparatus 600.

FIG. 8 is a schematic diagram showing a process of determining candidate fixed LISs according to an embodiment of the present disclosure. As shown in FIG. 8, the UE may be implemented as the electronic apparatus 600. In FIG. 8, four fixed LISs, namely fixed LIS1, fixed LIS2, fixed LIS3 and fixed LIS5 are included in transmission range of the gNB. Three fixed LISs, namely fixed LIS2, fixed LIS4 and fixed LIS5 are included in the reception range of the UE. As shown in FIG. 8, two fixed LISs, namely fixed LIS2 and fixed LIS5, are included in the overlapping region between the transmission range of the gNB and the reception range of the UE. Thus, the determination unit 630 may determine the fixed LIS2 and the fixed LIS5 as candidate fixed LISs.

According to the embodiments of the present disclosure, the determination unit 630 may also determine one or more candidate fixed LISs according to the channel quality of all fixed LISs within the serving range of the base station equipment.

According to the embodiments of the present disclosure, the measurement unit 610 may measure channel quality of each beam of all fixed LISs, so that the determination unit 630 may determine a fixed LIS with a beam whose channel quality is greater than a predetermined threshold as the candidate fixed LISs.

According to the embodiments of the present disclosure, the base station equipment may control all fixed LISs in the cell to perform beam scanning, so that the measurement unit 610 of the electronic apparatus 600 can measure the channel quality of each beam of each fixed LIS. Further, in a case that a fixed LIS has one or more beams whose channel quality is greater than the predetermined threshold, the fixed LIS is determined as the candidate fixed LISs.

According to the embodiments of the present disclosure, in a case that the electronic apparatus 600 has accessed the cell and the electronic apparatus 600 is served by a fixed LIS rather than directly served by the base station equipment, the determination unit 630 may directly determine the currently serving fixed LIS as the candidate fixed LISs.

Several embodiments of determining the candidate fixed LISs by the determination unit 630 are described above, and the determination unit 630 can combine the above embodiments according to needs. For example, in a case that the electronic apparatus 600 is served by a fixed LIS, the determination unit 630 directly determines the fixed LIS as the candidate fixed LISs. In a case that the electronic apparatus 600 is not served by a fixed LIS, the determination unit 630 may determine the candidate fixed LISs according to positions or channel quality.

According to the embodiments of the present disclosure, the determination unit 630 may determine one or more candidate fixed LISs. In a case that the determination unit 630 determines one candidate fixed LIS, the determination unit 620 is unnecessary to determine the fixed LIS, or a fixed LIS determined by the determination unit 620 is the candidate fixed LISs. In a case that the determination unit 630 determines more than one candidate fixed LIS, the determination unit 620 is required to select one fixed LIS from the candidate fixed LISs.

According to the embodiments of the present disclosure, as shown in FIG. 6, the electronic apparatus 600 may further include a communication unit 640 configured to receive information from other device than the electronic apparatus 600 and transmit information to other device than the electronic apparatus 600.

According to the embodiments of the present disclosure, as shown in FIG. 6, the electronic apparatus 600 may further include a generation unit 650 configured to generate various information transmitted to the base station equipment.

According to the embodiments of the present disclosure, after the determination unit 630 determines one or more candidate fixed LIS, the generation unit 650 may generate information of the candidate fixed LISs. The information of the candidate fixed LISs may include identification information of the fixed LIS. Optionally, the information of the candidate fixed LISs may further include identification information of a beam with the best channel quality of the candidate fixed LISs. Optionally, the information of the candidate fixed LISs may further include channel quality information of the beam, including but not limited to information such as reference signal receiving power (RSRP), channel state information (CSI), and quality of service (QOS).

According to the embodiments of the present disclosure, the electronic apparatus 600 may transmit the information of the one or more candidate fixed LISs generated by the generation unit 650 to the base station equipment through the communication unit 640.

According to the embodiments of the present disclosure, after the electronic apparatus 600 determines the candidate fixed LIS, information of the candidate region of the mobile LIS may be received from the base station equipment through the communication unit 640. Here, the base station equipment may determine the candidate region of the mobile LIS according to the transmission range of the candidate fixed LISs and the reception range of the electronic apparatus 600 that are reported by the electronic apparatus 600, which will be described in detail later.

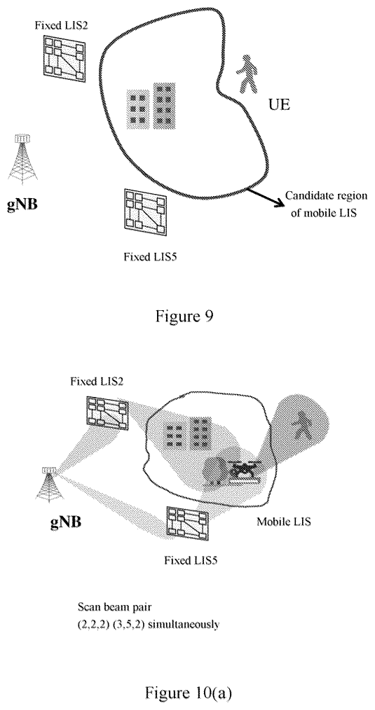

FIG. 9 is a schematic diagram showing a candidate region of a mobile LIS according to an embodiment of the present disclosure. As shown in FIG. 9, the candidate region of the mobile LIS is shown as an irregular shape. That is, a final position of the mobile LIS is in the candidate region.

Further, according to the candidate region of the mobile LIS, the electronic apparatus 600 can roughly align a received beam with the candidate region of the mobile LIS. After determining the final position of the mobile LIS, the electronic apparatus 600 can accurately align the received beam with the mobile LIS.

According to the embodiments of the present disclosure, after the electronic apparatus 600 determines the candidate fixed LISs and the base station equipment determines the candidate region of the mobile LIS, the base station may control the candidate fixed LISs and the mobile LIS to perform beam scanning.

According to the embodiments of the present disclosure, the base station equipment may specify that the mobile LIS has candidate positions in Q directions in the candidate region of the mobile LIS. For example, in a case of Q=4, the base station equipment may select one position in each of four directions, namely the east, the south, the west and the north in the candidate region of the mobile LIS as the candidate position of the mobile LIS. For another example, in a case of Q-8, the base station equipment may select one position in each of eight directions, namely the east, the south, the west, the north, the southeast, the northeast, the southwest and the northwest in the candidate region of mobile LIS as the candidate position of mobile LIS. Further, the base station equipment may allocate identification information for each candidate position.

According to the embodiments of the present disclosure, it is assumed that each candidate fixed LIS has M beams (which refers to narrow beams described later, that is, beams finally serving the electronic apparatus 600), the number of the candidate fixed LISs is P, the mobile LIS has N beams (which refers to narrow beams described later, that is, beams finally serving the electronic apparatus 600), and the mobile LIS has Q directions in the candidate region of the mobile LIS. In general, it is required to perform scanning for M*P*N*Q times, which is a large number.

According to the embodiments of the present disclosure, in order to reduce the number of times for which scanning is performed, the base station equipment may control the candidate fixed LISs and the mobile LIS to perform wide beam scanning to select the fixed LIS, a serving wide beam of the fixed LIS and a serving wide beam of the mobile LIS, and optionally the position of the mobile LIS.

According to the embodiments of the present disclosure, the wide beam may include a group of multiple adjacent narrow beams, and a size of the narrow beam is equal to a size of a beam that ultimately serves the electronic apparatus 600. Therefore, in the present disclosure, the beam refers to the narrow beam and the wide beam refers to a group of narrow beams.

Some examples of wide beam combinations are shown in the following table. In the following table, a combination (m, p, n, q) represents a case in which a p-th fixed LIS uses an m-th wide beam, the mobile LIS is at a q-th candidate position and uses an n-th wide beam.

TABLE 1

| Serial number | Wide beam combination |
|---|---|
| 1 | (1, 2, 1, 1) |
| 2 | (2, 2, 1, 1) |
| 3 | (3, 2, 3, 2) |
| 4 | (3, 2, 3, 3) |

According to the embodiments of the present disclosure, the measurement unit 610 may measure the channel quality of each wide beam of the mobile LIS and the wide beams of one or more candidate fixed LIS, so that the determination unit 620 determines the fixed LIS, the serving wide beam of the fixed LIS, the position of the mobile LIS and the serving wide beam of the mobile LIS according to the measurement results of the measurement unit 610.

Specifically, the determination unit 620 may select a combination with the best signal quality from the measurement results of the measurement unit 610, so as to select one fixed LIS from the candidate fixed LIS, determine a serving wide beam of the fixed LIS, select a position from the candidate positions of the mobile LIS, and determine the serving wide beam of the mobile LIS.

According to the embodiments of the present disclosure, the LIS may be transparent or opaque to the electronic apparatus 600. In a case that the LIS is transparent, the electronic apparatus 600 does not know the correspondence between the serial numbers and the wide beam combinations, but only knows a serial number of the combination with the best channel quality. In a case that the LIS is opaque, the electronic apparatus 600 knows the correspondence between the serial numbers and the wide beam combinations, that is, the fixed LIS, the wide beam of the fixed LIS, the position of the mobile LIS and the wide beam of the mobile LIS that correspond to the combination with the best channel quality.

According to the embodiments of the present disclosure, after the determination unit 620 determines the fixed LIS, the serving wide beam of the fixed LIS, the position of the mobile LIS, and the serving wide beam of the mobile LIS, the generation unit 650 may generate information of the wide beam combination and the electronic apparatus 600 may transmit the information of the wide beam combination generated by the generation unit 650 to the base station equipment through the communication unit 640.

According to the embodiments of the present disclosure, in a case that the LIS is transparent, the information of the wide beam combination may include index information. The index information corresponds to the fixed LIS, the serving wide beam of the fixed LIS, the position of the mobile LIS and the serving wide beam of the mobile LIS. For example, in a case that the determination unit 620 determines that the channel quality of the wide beam combination (2,2,1,1) in Table 1 is the best, the information of the wide beam combination may include index information “2”, so that the base station equipment can determine the wide beam combination (2,2,1,1) according to the correspondence in Table 1.

According to the embodiments of the present disclosure, in a case that the LIS is opaque, the information of the wide beam combination may include identification information of the fixed LIS, identification information of the serving wide beam of the fixed LIS, identification information of the position of the mobile LIS, and identification information of the serving wide beam of the mobile LIS. For example, in a case that the determination unit 620 determines that the channel quality of the wide beam combination (2,2,1,1) in Table 1 is the best, the information of the wide beam combination may include identification information “2” of the fixed LIS, identification information “2” of the serving wide beam of the fixed LIS, identification information “1” of the position of the mobile LIS, and identification information “1” of the serving wide beam of the mobile LIS.

According to the embodiments of the present disclosure, in order to further reduce the number of times for which scanning is performed, the base station equipment may further implicitly represent the position of the mobile LIS. Specifically, according to the position of the electronic apparatus 600, the base station equipment may determine an optimal wide beam when the mobile LIS is located in each of the candidate positions. That is, the candidate position of the mobile LIS has a one-to-one correspondence with one optimal wide beam. For example, when the mobile LIS is located in the “south” in the candidate region of the mobile LIS and the electronic apparatus 600 is located in the northeast of the mobile LIS, it is determined that the wide beam in the northeast of the mobile LIS has a one-to-one correspondence with the “south” candidate position. In other words, when the mobile LIS is in the “south”, scanning is performed only on the wide beam towards the northeast. In this way, in the above embodiments, the parameter q, namely the candidate position of the mobile LIS may be omitted, thereby further reducing the number of times for which scanning is performed.

The following table shows examples of some wide beam combinations after the parameter q, namely the candidate position of the mobile LIS is omitted. In the following table, the combination (m, p, n) represents a case in which a p-th fixed LIS uses an m-th wide beam and the mobile LIS uses an n-th wide beam.

TABLE 2

| Serial number | Wide beam combination |
|---|---|
| 1 | (1, 2, 1) |
| 2 | (2, 2, 2) |
| 3 | (3, 2, 3) |
| 4 | (3, 2, 4) |

In this case, the determination unit 620 may select a combination with the best signal quality from the measurement results of the measurement unit 610, so as to select one fixed LIS from the candidate fixed LIS, determine the serving wide beam of the fixed LIS, determine the serving wide beam of the mobile LIS, and determine the candidate position of the corresponding mobile LIS according to the serving wide beam of the mobile LIS.

In this case, in a case that the LIS is transparent, the information of the wide beam combination generated by the generation unit 650 may include index information. The index information corresponds to the fixed LIS, the serving wide beam of the fixed LIS, and the serving wide beam of the mobile LIS. For example, in a case that the determination unit 620 determines that the channel quality of the wide beam combination (3,2,3) in Table 2 is the best, the information of the wide beam combination may include index information “3”, so that the base station equipment can determine the wide beam combination (3,2,3) according to the correspondence in Table 2 and determine the position of the mobile LIS according to the wide beam 3 of the mobile LIS.

According to the embodiments of the present disclosure, in a case that the LIS is opaque, the information of the wide beam combination generated by the generation unit 650 may include the identification information of the fixed LIS, the identification information of the serving wide beam of the fixed LIS, and the identification information of the serving wide beam of the mobile LIS. For example, in a case that the determination unit 620 determines that the channel quality of the wide beam combination (3,2,3) in Table 2 is the best, the information of the wide beam combination may include the identification information “2” of the fixed LIS, the identification information “3” of the serving wide beam of the fixed LIS, and the identification information “3” of the serving wide beam of the mobile LIS, so that the base station equipment can determine the position of the mobile LIS according to the wide beam 3 of the mobile LIS.

According to the embodiments of the present disclosure, the base station equipment, when configuring a reference signal (RS), may configure an RS without being pre-coded/beam-formed, that is, same frequency domain resources are used to carry RSs of different candidate fixed LISs. In this case, it is required to carry RSs of different candidate fixed LISs using different time-domain resources. According to the embodiments of the present disclosure, the base station equipment may allocate different time for different candidate fixed LISs, so that each of the candidate fixed LISs is opened only in the allocated time for performing beam scanning.

According to the embodiments of the present disclosure, the base station equipment, when configuring an RS, may also configure a pre-coded/beam-formed RS. In this case, since different frequency-domain resources are used to carry RSs of different candidate fixed LISs, the same time-domain resources may be used to carry RSs of different candidate fixed LISs. That is, the candidate fixed LISs may perform beam scanning simultaneously to save time spent on scanning.

The following table shows examples of some wide beam combination pairs in a case of configuring the pre-coded/beam-formed RS. In the following table, a combination pair (m1, p1, n, q) (m2, p2, n, q) represents a case where a p1-th fixed LIS uses an m1-th wide beam and a p2-th fixed LIS uses an m2-th wide beam at the same time, and the mobile LIS is in a q-th candidate position and uses an n-th wide beam.

TABLE 3

| Serial number | Wide beam combination pair |
|---|---|
| 1 | (1, 2, 1, 1) (2, 5, 1, 1) |
| 2 | (2, 2, 1, 1) (3, 5, 1, 1) |
| 3 | (3, 2, 3, 2) (1, 5, 3, 2) |
| 4 | (2, 2, 3, 3) (1, 5, 3, 3) |

According to the embodiments of the present disclosure, the measurement unit 610 may measure channel quality of each wide beam combination pair, so that the determination unit 620 determines an optimal wide beam combination pair according to measurement results of the measurement unit 610.

According to the embodiments of the present disclosure, after the determination unit 620 determines the optimal wide beam combination pair, the generation unit 650 may generate information of the wide beam combination pair and the electronic apparatus 600 may transmit the information of the wide beam combination pair generated by the generation unit 650 to the base station equipment through the communication unit 640.

According to the embodiments of the present disclosure, in a case that the LIS is transparent, the information of the wide beam combination pair may include index information. The index information corresponds to the wide beam combination pair. The wide beam combination pair includes two wide beam combinations each of which includes a fixed LIS, a serving wide beam of the fixed LIS, a position of a mobile LIS, and a serving wide beam of the mobile LIS. For example, in a case that the determination unit 620 determines that the channel quality of the wide beam combination pair (2,2, 1,1) (3,5,1,1) in Table 3 is the best, the information of the wide beam combination pair may include index information “2”, so that the base station equipment can determine the wide beam combination pair (2,2,1,1) (3,5,1, 1) according to the correspondence in Table 3.

According to the embodiments of the present disclosure, in a case that the LIS is opaque, the information of the wide beam combination pair may include information of two wide beam combinations, and information of each of the wide beam combinations includes identification information of the fixed LIS, identification information of the serving wide beam of the fixed LIS, identification information of the position of the mobile LIS, and identification information of the serving wide beam of the mobile LIS. For example, in a case that the determination unit 620 determines that the channel quality of the wide beam combination pair (2,2, 1,1) (3,5,1,1) in Table 3 is the best, the information of the wide beam combination pair may include information of two wide beam combinations. Information of one of the wide beam combinations includes identification information “2” of the fixed LIS, identification information “2” of the serving wide beam of the fixed LIS, identification information “1” of the position of the mobile LIS, and identification information “1” of the serving wide beam of the mobile LIS. Information of the other of the wide beam combinations includes identification information “5” of the fixed LIS, identification information “3” of the serving wide beam of the fixed LIS, identification information “1” of the position of the mobile LIS, and identification information “1” of the serving wide beam of the mobile LIS.

In this embodiment, after receiving the information of the wide beam combination pair, the base station equipment cannot determine whether the channel quality of the wide beam combination (2,2, 1,1) or the wide beam combination (3,5,1,1) is the best. Therefore, the base station equipment may select one wide beam combination to retransmit the reference signal, so that the electronic apparatus 600 can measure the channel quality with respect to the retransmitted signal and feed back to the base station equipment whether the channel quality is greater than a predetermined threshold. In a case that the channel quality is greater than the predetermined threshold, the base station equipment determines the fixed LIS, the serving wide beam of the fixed LIS, the position of the mobile LIS and the serving wide beam of the mobile LIS according to the wide beam combination. In a case that the channel quality is not greater than the predetermined threshold, the base station equipment determines the fixed LIS, the serving wide beam of the fixed LIS, the position of the mobile LIS and the serving wide beam of the mobile LIS according to another wide beam combination.

Similarly, in a case that the candidate positions of the mobile LIS and the wide beams of the mobile LIS are in one-to-one correspondence, the parameter q, namely the candidate position of the mobile LIS may be omitted. The following table shows some examples of wide beam combination pairs in a case that the parameter q, namely the candidate position of the mobile LIS is omitted. In the following table, a combination (m1, p1, n) (m2, p2, n) represents a case where a p1-th fixed LIS uses an m1-th wide beam and a p2-th fixed LIS uses an m2-th wide beam at the same time, and the mobile LIS uses an n-th wide beam.

TABLE 4

| Serial number | Wide beam combination pair |
|---|---|
| 1 | (1, 2, 1) (2, 5, 1) |
| 2 | (2, 2, 1) (3, 5, 1) |
| 3 | (3, 2, 3) (1, 5, 3) |
| 4 | (2, 2, 3) (1, 5, 3) |

According to the embodiments of the present disclosure, the measurement unit 610 may measure channel quality of each wide beam combination pair, so that the determination unit 620 determines an optimal wide beam combination pair according to measurement results of the measurement unit 610.

According to the embodiments of the present disclosure, after the determination unit 620 determines the optimal wide beam combination pair, the generation unit 650 may generate information of the wide beam combination pair and the electronic apparatus 600 may transmit the information of the wide beam combination pair generated by the generation unit 650 to the base station equipment through the communication unit 640.

According to the embodiments of the present disclosure, in a case that the LIS is transparent, the information of the wide beam combination pair may include index information. The index information corresponds to the wide beam combination pair. The wide beam combination pair includes two wide beam combinations each of which includes a fixed LIS, a serving wide beam of the fixed LIS, and a serving wide beam of a mobile LIS. For example, in a case that the determination unit 620 determines that the channel quality of the wide beam combination pair (2,2,1) (3,5,1) in Table 4 is the best, the information of the wide beam combination pair may include index information “2”, so that the base station equipment can determine the wide beam combination pair (2,2,1) (3,5,1) according to the correspondence in Table 4 and determine the position of the mobile LIS according to the wide beam 1 of the mobile LIS.

According to the embodiments of the present disclosure, in a case that the LIS is opaque, the information of the wide beam combination pair may include information of two wide beam combinations. The information of each wide beam combination includes identification information of the fixed LIS, identification information of the serving wide beam of the fixed LIS, and identification information of the serving wide beam of the mobile LIS. For example, in a case that the determination unit 620 determines that the channel quality of the wide beam combination pair (2,2,1) (3,5,1) in Table 4 is the best, the information of the wide beam combination pair may include information of two wide beam combinations. Information of one of the wide beam combination includes identification information “2” of the fixed LIS, identification information “2” of the serving wide beam of the fixed LIS, and identification information “1” of the serving wide beam of the mobile LIS. Information of the other wide beam combination includes identification information “5” of the fixed LIS, identification information “3” of the serving wide beam of the fixed LIS, and identification information “1” of the serving wide beam of the mobile LIS. The base station equipment may determine the position of the mobile LIS according to the wide beam 1 of the mobile LIS.

In this embodiment, after receiving the information of the wide beam combination pair, the base station equipment cannot determine whether the channel quality of the wide beam combination (2,2,1) or the wide beam combination (3,5,1) is the best. Therefore, the base station equipment may select a wide beam combination to retransmit the reference signal, so that the electronic apparatus 600 can measure channel quality with respect to the retransmission signal and feed back to the base station equipment whether the channel quality is greater than the predetermined threshold. In a case that the channel quality is greater than the predetermined threshold, the base station equipment can determine the fixed LIS, the serving wide beam of the fixed LIS and the serving wide beam of the mobile LIS according to a wide beam combination. In a case that the channel quality is not greater than the predetermined threshold, the base station equipment can determine the fixed LIS, the serving wide beam of the fixed LIS and the serving wide beam of the mobile LIS according to another wide beam combination.

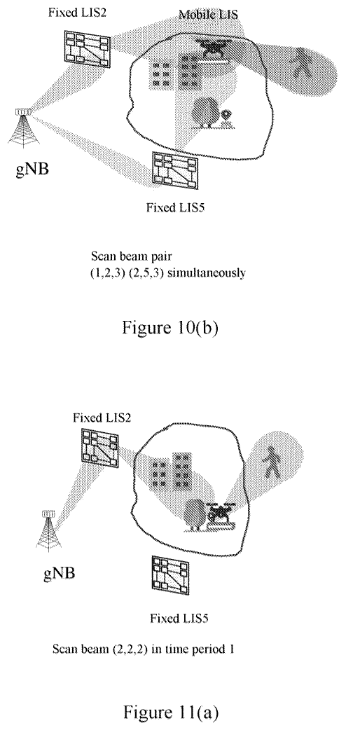

FIG. 10(a) and FIG. 10(b) each are a schematic diagram showing a process of two fixed LISs performing wide beam scanning simultaneously according to an embodiment of the present disclosure. In FIG. 10(a) and FIG. 10(b), the base station equipment configures a pre-coded/beam-formed RS. In addition, FIG. 10(a) and FIG. 10(b) show a case where the parameter q, namely the candidate position of the mobile LIS is omitted.

As shown in FIG. 10(a), wide beam pairs (2,2,2) and (3,5,2) may be scanned simultaneously. That is, a fixed LIS2 uses a wide beam 2, a fixed LIS5 uses a wide beam 3, and a mobile LIS uses the wide beam 2. As shown in FIG. 10(b), a wide beam pair (1,2,3) and (2,5,3) may be scanned simultaneously. That is, the fixed LIS2 uses a wide beam 1, the fixed LIS5 uses the wide beam 2, and the mobile LIS uses the wide beam 3.

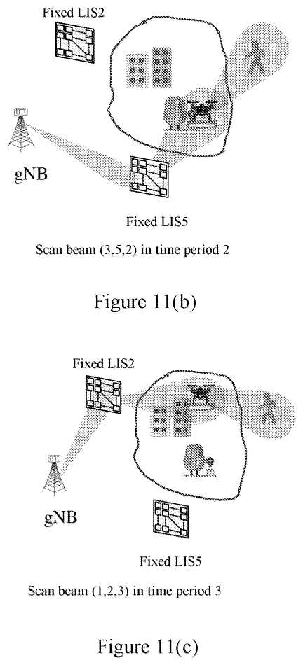

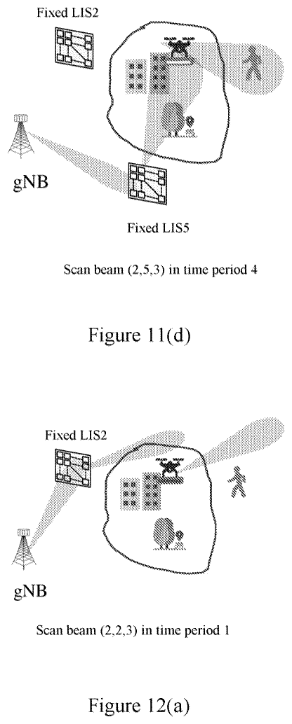

FIG. 11(a) to FIG. 11(d) each are a schematic diagram showing a process of two fixed LISs performing wide beam scanning at different times according to an embodiment of the present disclosure. In FIG. 11(a) to FIG. 11(d), the base station equipment configures an RS without being pre-coded/beam-formed. In addition, FIGS. 11(a) to 11(d) show a case where the parameter q, namely the candidate position of the mobile LIS, is omitted.

As shown in FIG. 11(a), a wide beam pair (2,2,2) is scanned in a time period 1. That is, a fixed LIS2 uses a wide beam 2 and a mobile LIS uses the wide beam 2. As shown in FIG. 11(b), a wide beam pair (3,5,2) is scanned in a tome period 2. That is, a fixed LIS5 uses a wide beam 3 and the mobile LIS uses the wide beam 2. As shown in FIG. 11(c), a wide beam pair (1,2,3) is scanned in a time period 3. That is, the fixed LIS2 uses the wide beam 1 and the mobile LIS uses the wide beam 3. As shown in FIG. 11(d), a wide beam pair (2,5,3) is scanned in a time period 4. That is, the fixed LIS5 uses the wide beam 2 and the mobile LIS uses the wide beam 3.

The process of wide beam scanning is described in detail above. After the wide beam scanning, the fixed LIS, the serving wide beam of the fixed LIS, the position of the mobile LIS and the serving wide beam of the mobile LIS are determined. In this way, the base station equipment can control the mobile LIS to reach the determined position, and reconfigure the reference signal, select the direction of the fixed LIS and the direction of the mobile LIS, so that the fixed LIS performs narrow beam scanning within the serving wide beam of the fixed LIS and the mobile LIS performs narrow beam scanning within the serving wide beam of the mobile LIS.

According to the embodiments of the present disclosure, the measurement unit 610 may measure channel quality of narrow beams within the serving wide beam of the mobile LIS and narrow beams within the serving wide beam of the fixed LIS. Further, the determination unit 620 may determine a serving narrow beam of the fixed LIS and a serving narrow beam of the mobile LIS according to measurement results of the measurement unit 610.

Examples of some narrow beam combinations are shown in the following table. It is assumed that the fixed LIS2 is selected in the wide beam scanning. In the following table, a combination (x, p, y) represents a case where a p-th fixed LIS uses an x-th narrow beam within the serving wide beam and the mobile LIS uses a y-th narrow beam within the serving wide beam.

TABLE 5

| Serial number | Narrow beam combination |
|---|---|
| 1 | (2, 2, 3) |
| 2 | (3, 2, 4) |
| 3 | (4, 2, 5) |

According to the embodiments of the present disclosure, the determination unit 620 may select a narrow beam combination with the best signal quality from measurement results of the measurement unit 610, so as to determine the serving narrow beam of the fixed LIS and the serving narrow beam of the mobile LIS.

According to the embodiments of the present disclosure, after the determination unit 620 determines the serving narrow beam of the fixed LIS and the serving narrow beam of the mobile LIS, the generation unit 650 may generate information of a narrow beam combination and the electronic apparatus 600 may transmit the information of the narrow beam combination generated by the generation unit 650 to the base station equipment through the communication unit 640.

According to the embodiments of the present disclosure, in a case that the LIS is transparent, the information of the narrow beam combination may include index information. The index information corresponds to the narrow beam of the fixed LIS and the narrow beam of the mobile LIS. For example, in case that the determination unit 620 determines that the channel quality of the narrow beam combination (3,2,4) in Table 5 is the best, the information of the narrow beam combination may include index information “2”, so that the base station equipment can determine the narrow beam combination (3,2,4) according to the correspondence in Table 5.

According to the embodiments of the present disclosure, in a case that the LIS is opaque, the information of the narrow beam combination may include identification information of the serving narrow beam of the fixed LIS and identification information of the serving narrow beam of the mobile LIS. For example, in a case that the determination unit 620 determines that the channel quality of the narrow beam combination (3,2,4) in Table 5 is the best, the information of the narrow beam combination may include identification information “3” of the serving narrow beam of the fixed LIS and identification information “4” of the serving narrow beam of the mobile LIS. Optionally, the information of the narrow beam combination may further include identification information “2” of the fixed LIS.

According to the embodiments of the present disclosure, in a case that the serving wide beam of the fixed LIS includes X narrow beams and the serving wide beam of the mobile LIS includes Y narrow beams, if the measurement unit 610 measures the channel quality of all the narrow beam combinations and then the determination unit 620 determines the narrow beam combination with the best channel quality, it is required to perform scanning for X*Y times. In order to reduce the number of times for which scanning is performed, for each of the narrow beam combinations, the determination unit 620 may determine whether channel quality of the narrow beam combination meets a predetermined condition (for example, whether greater than a predetermined threshold) after the measurement unit 610 measures the channel quality of the narrow beam combination, and scanning is stopped if the predetermined condition is met.

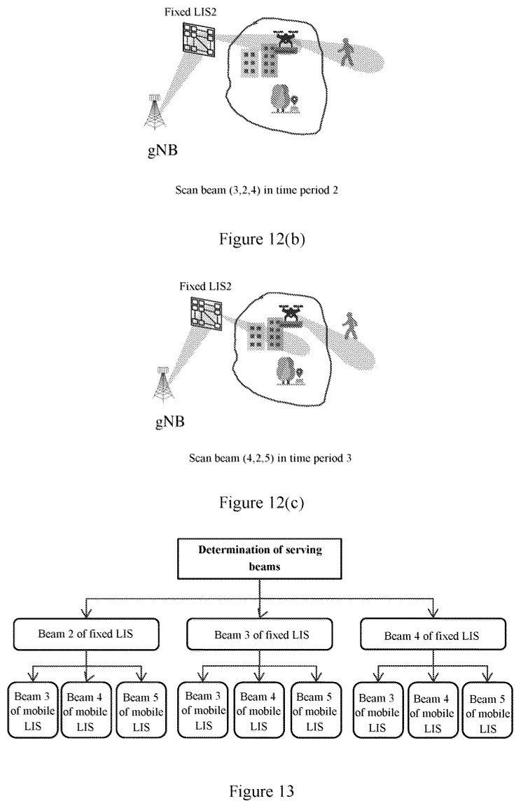

FIG. 12(a) to FIG. 12(c) each are a schematic diagram showing a process of the fixed LIS and the mobile LIS performing narrow beam scanning according to an embodiment of the present disclosure. As shown in FIG. 12(a), a narrow beam pair (2,2,3) is scanned in a time period 1. That is, a fixed LIS2 uses a narrow beam 2 and a mobile LIS uses a narrow beam 3. As shown in FIG. 12(b), a narrow beam pair (3,2,4) is scanned in a time period 2. That is, the fixed LIS2 uses the narrow beam 3 and the mobile LIS uses a narrow beam 4. As shown in FIG. 12(c), a narrow beam pair (4,2,5) is scanned in a time period 3. That is, the fixed LIS2 uses the narrow beam 4 and the mobile LIS uses a narrow beam 5.

FIG. 13 is a schematic diagram showing determination of the number of times of scanning of a serving beam of the fixed LIS and the number of times of scanning of a serving beam of the mobile LIS according to an embodiment of the present disclosure. Here, it is assumed that the serving wide beam of the fixed LIS includes three narrow beams numbered 2, 3 and 4 respectively, and the serving wide beam of the mobile LIS includes three narrow beams numbered 3, 4 and 5 respectively. It is assumed that the optimal narrow beam combination is (3,2,4). If the measurement unit 610 measures the channel quality of all narrow beam combinations and then the determination unit 620 determines the narrow beam combination with the best channel quality, it is required to perform scanning for nine times to determine the optimal narrow beam combination. If for each of the narrow beam combinations, the determination unit 620 determines whether channel quality of the narrow beam combination meets the predetermined condition (for example, whether greater than the predetermined threshold) after the measurement unit 610 measures the channel quality of the narrow beam combination and scanning is stopped when the predetermined condition is met, it is required to perform scanning for five times to determine the optimal narrow beam combination, thereby reducing the number of times for which scanning is performed and saving time spent on scanning.

According to the embodiments of the present disclosure, after the serving narrow beam of the fixed LIS and the serving narrow beam of the mobile LIS are determined, the base station equipment may control the direction of the fixed LIS and the direction of the mobile LIS, so that the electronic apparatus 600 is served by the serving narrow beam of the fixed LIS and the serving narrow beam of the mobile LIS. The present disclosure is applicable to downlink transmission, and therefore the electronic apparatus 600 can receive downlink information from the base station equipment through the serving narrow beam of the fixed LIS and the serving narrow beam of the mobile LIS.

According to the embodiments of the present disclosure, as shown in FIG. 6, the electronic apparatus 600 may further include a decision unit 660 configured to determine to serve the electronic apparatus 600 by the fixed LIS and the mobile LIS in a case that channel quality of each of all currently available beams is lower than a predetermined threshold.

According to the embodiments of the present disclosure, in a 5G NR communication system, it is assumed that the user has W beams for downlink control channel transmission. If the channel quality of each of the W beams is lower than a predetermined threshold Tₚ, the user determines that a beam failure event occurs. According to the embodiments of the present disclosure, a predetermined threshold T_{L} may be defined, where T_{L}<Tₚ. In a case that the channel quality of a beam currently serving the electronic apparatus 600 is lower than the predetermined threshold T_{L} or close to (a difference from the predetermined threshold T_{L} is lower than a threshold) the predetermined threshold T_{L}, the generation unit 650 may generate request information to request performing beam measurement, so that the electronic apparatus 600 transmits the generated request information to the base station equipment through the communication unit 640. Further, the measurement unit 610 may measure the channel quality of all currently available beams according to the reference signal from the base station equipment, so that the decision unit 660, in a case that the channel quality of each of the all currently available beams is lower than the predetermined threshold, determines to jointly serve the electronic apparatus 600 by the fixed LIS and the mobile LIS. Next, the determination unit 630 may perform the operation of determining the candidate fixed LISs described above.

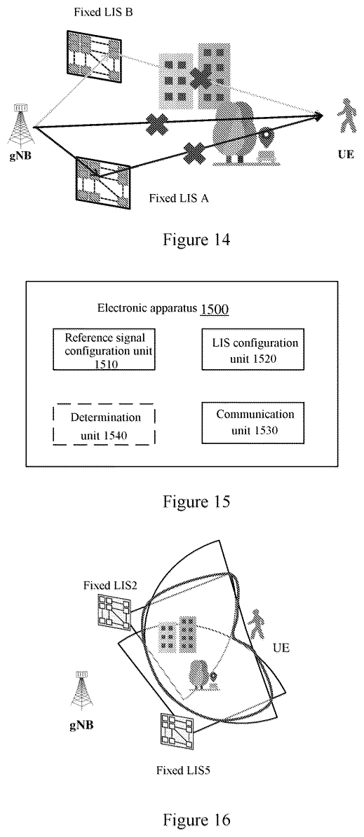

FIG. 14 is a schematic diagram showing a scenario in which channel quality of all currently available beams of the UE is very poor according to an embodiment of the present disclosure. As shown in FIG. 14, there are three currently available channels between the gNB and the UE. A direct path between the gNB and the UE has poor channel quality because the direct path is blocked by trees. It is assumed that the channel quality of the path measured by the UE is lower than the predetermined threshold T_{L} and the UE may request the gNB to perform beam measurement. Further, according to a reference signal from the gNB, the UE measures that channel quality of a channel assisted by a fixed LIS A is lower than the predetermined threshold and channel quality of a channel assisted by a fixed LIS B is also lower than the predetermined threshold, so that the UE may determine that the fixed LIS and the mobile LIS jointly serve the UE.

It should be noted that, according to the embodiments of the present disclosure, the measurement unit 610, when measuring channel quality of the wide beam combination, the wide beam combination pair and the narrow beam combination, may measure parameters representing the quality of the channel, including but not limited to SIR (signal to interference ratio), SINR (signal to interference plus noise ratio), SNR (signal to interference ratio), RSRP (reference signal receiving power), CSI (channel state information) and QoS (quality of service). In addition, the beam scanning process in the embodiments of the present disclosure may be performed in a manner well known in the art. For example, the base station equipment transmits the RS through different channels/beams, and the electronic apparatus 600 measures the channel quality of different channels/beams. The beam scanning process is not limited in the present disclosure.

It can be seen that according to the embodiments of the present disclosure, the electronic apparatus 600 may select the fixed LIS, the serving beam of the fixed LIS and the serving beam of the mobile LIS according to the channel quality of the beams of the mobile LIS and the beams of the fixed LIS, and the fixed LIS and the mobile LIS jointly serve the electronic apparatus 600. In addition, the electronic apparatus 600 may first select the fixed LIS, determine the serving wide beam of the fixed LIS and the serving wide beam of the mobile LIS, and then determine the serving narrow beam of the fixed LIS and the serving narrow beam of the mobile LIS, so as to save the time spent on scanning. Further, in a case that the base station equipment configures the pre-coded/beam-formed RS, the electronic apparatus 600 may scan serving wide beams from different fixed LIS simultaneously, thereby further saving the time spent on scanning. In short, according to the embodiments of the present disclosure, the advantages of the fixed LIS and the mobile LIS can be combined, thereby improving the communication quality of the electronic apparatus 600.

### <3. Configuration Examples of Network Side Equipment>

FIG. 15 is a structural block diagram of an electronic apparatus 1500 serving as a network side equipment in a wireless communication system according to an embodiment of the present disclosure. The network side equipment here may be, for example, a base station equipment.

As shown in FIG. 15, the electronic apparatus 1500 may include a reference signal configuration unit 1510, an LIS configuration unit 1520, and a communication unit 1530.

Here, each unit of the electronic apparatus 1500 may be included in a processing circuitry. It should be noted that the electronic apparatus 1500 may include one processing circuitry or multiple processing circuits. Further, the processing circuitry may include various discrete functional units to perform different functions and/or operations. It should be noted that these functional units may be physical entities or logical entities, and units with different names may be implemented by a same physical entity.

According to the embodiments of the present disclosure, the reference signal configuration unit 1510 may configure a reference signal for user equipment to measure channel quality of a downlink channel by the user equipment. Further, the electronic apparatus 1500 may transmit the reference signal to the user equipment through the communication unit 1530.

According to the embodiments of the present disclosure, the LIS configuration unit 1520 may configure a direction of a fixed LIS, and a position and a direction of a mobile LIS.

According to the embodiments of the present disclosure, the reference signal configuration unit 1510 may configure the reference signal. The LIS configuration unit 1520 may configure the position and direction of the mobile LIS, and the direction of one or more candidate fixed LISs, so that the user equipment measures the channel quality of multiple beams of the mobile LIS and multiple beams of the one or more candidate fixed LISs, and determine the fixed LIS, the serving beam of the fixed LIS, and the serving beam of the mobile LIS.

According to the embodiments of the present disclosure, the electronic apparatus 1500 may receive information of the determined fixed LIS, serving beam of the fixed LIS and serving beam of the mobile LIS from the user equipment through the communication unit 1530.

According to the embodiments of the present disclosure, according to the information from the user equipment, the LIS configuration unit 1520 may configure the direction of the mobile LIS and the direction of the fixed LIS, so that the serving beam of the fixed LIS and the serving beam of the mobile LIS serve the user equipment.

As described above, the electronic apparatus 1500 according to the embodiments of the present disclosure may configure the reference signal, the direction of the fixed LIS, and the position and direction of the mobile LIS for the user equipment, so that the user equipment can select the fixed LIS, the serving beam of the fixed LIS, and the serving beam of the mobile LIS according to the channel quality of the beams of the mobile LIS and the beams of the fixed LIS. In this way, the fixed LIS and the mobile LIS jointly serve the user equipment to combine the advantages of the fixed LIS and the mobile LIS, thereby improving the communication quality of the user equipment.

According to the embodiments of the present disclosure, the electronic apparatus 1500 may receive information of one or more candidate fixed LISs from the user equipment through the communication unit 1530.

According to the embodiments of the present disclosure, as shown in FIG. 15, the electronic apparatus 1500 may further include a determination unit 1540 configured to determine a candidate region of the mobile LIS according to transmission range of one or more candidate fixed LISs and reception range of the user equipment.

Specifically, the determination unit 1540 may determine an overlapping region between the transmission range of each candidate fixed LIS and the reception range of the user equipment, and determine the candidate region of the mobile LIS to include all overlapping regions. Here, the transmission range of the candidate fixed LIS represents range within which a signal from the candidate fixed LIS can be received, and is generally a sector with the candidate fixed LIS as a center. The reception range of the user equipment represents range within which the user equipment can receive a signal from other device, and is generally a circle with the user equipment as a center. That is, in the candidate region of the mobile LIS, the mobile LIS can receive the channel of any one of the candidate fixed LISs and the user equipment can receive the signal from the mobile LIS.

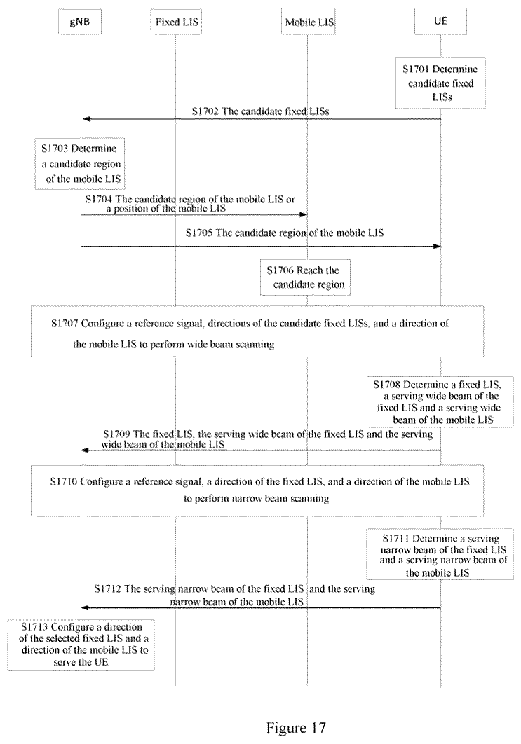

FIG. 16 is a schematic diagram showing a process of determining a candidate region of a mobile LIS according to an embodiment of the present disclosure. In FIG. 16, there are two candidate fixed LISs, namely a fixed LIS2 and a fixed LIS5. Transmission range of the fixed LIS2 is shown as a sector with the fixed LIS2 as a center in the Figure, and transmission range of the fixed LIS5 is shown as a sector with the fixed LIS5 as a center in the Figure. For simplicity, reception range of UE is shown as a semicircle with the UE as a center in the Figure. FIG. 16 shows the candidate region of the mobile LIS as an irregular shape, which is a union of the following two regions: the overlapping region between the transmission range of the fixed LIS2 and the reception range of the UE; the overlapping region between the transmission range of the LIS5 and the reception range of the UE.

According to the embodiments of the present disclosure, after the determination unit 1540 determines the candidate region of the mobile LIS, the electronic apparatus 1500 may control the mobile LIS to enter the candidate region.

According to the embodiments of the present disclosure, various positions of multiple mobile LISs within the coverage of the electronic apparatus 1500 may be preset. After the candidate region of the mobile LIS is determined, the electronic apparatus 1500 may activate one mobile LIS (for example, the mobile LIS closest to the candidate region of the mobile LIS) and control the mobile LIS to enter the candidate region.

According to the embodiments of the present disclosure, in a case that the mobile LIS is an active mobile LIS, the mobile LIS has abilities to measure and report. The electronic apparatus 1500 may transmit a position of the candidate region of the mobile LIS to the mobile LIS. The mobile LIS, after flying to the candidate region, transmits position information to the electronic apparatus 1500. In a case that the mobile LIS is a passive mobile LIS, the mobile LIS has no ability to measure and report. The electronic apparatus 1500 may transmit an exact address (for example, longitude, latitude and altitude) of a position in the candidate region to the mobile LIS, and the mobile LIS directly flies to the exact address.

According to the embodiments of the present disclosure, the determination unit 1540 may further determine serving time of the mobile LIS. For example, the determination unit 1540 may estimate time when the user equipment requires a service, so as to determine the serving time of the mobile LIS.

According to the embodiments of the present disclosure, after the determination unit 1540 determines the candidate region of the mobile LIS, the electronic apparatus 1500 may further transmit the candidate region (optionally, may further including the service time of the mobile LIS) of the mobile LIS to the user equipment through the communication unit 1530.

According to the embodiments of the present disclosure, after the determination unit 1540 determines the candidate region of the mobile LIS, the electronic apparatus 1500 may configure the candidate position of the mobile LIS. For example, the electronic apparatus 1500 may specify that the mobile LIS has candidate positions in Q directions respectively in the candidate region of the mobile LIS. For example, in a case of Q=4, the electronic apparatus 1500 may select one position in each of four directions, namely the east, the south, the west and the north in the candidate region of the mobile LIS as the candidate position of the mobile LIS. For another example, in a case of Q-8, the electronic apparatus 1500 may select one position in each of eight directions, namely the east, the south, the west, the north, the southeast, the northeast, the southwest and the northwest in the candidate region of mobile LIS as the candidate position of mobile LIS. Further, the electronic apparatus 1500 may configure identification information for each candidate position.

According to the embodiments of the present disclosure, the electronic apparatus 1500 may configure a reference signal, a position and direction of the mobile LIS, and a direction of the candidate fixed LIS, to perform wide beam scanning.

Specifically, the electronic apparatus 1500 may configure multiple wide beam combinations, as shown in Table 1 above. The combination (m, p, n, q) represents a case where the p-th fixed LIS uses the m-th wide beam, the mobile LIS is at the q-th candidate position and uses the n-th wide beam. In this way, the user equipment can measure the channel quality of each wide beam of the mobile LIS at various candidate positions and wide beams of one or more candidate fixed LISs, and determine the fixed LIS, the serving wide beam of the fixed LIS, the position of the mobile LIS and the serving wide beam of the mobile LIS according to measurement results.

According to the embodiments of the present disclosure, after the wide beam scanning, the electronic apparatus 1500 may receive information of the wide beam combination from the user equipment through the communication unit 1530. The information of the wide beam combination may include identification information of the fixed LIS, identification information of the serving wide beam of the fixed LIS, identification information of the position of the mobile LIS and identification information of the serving wide beam of the mobile LIS. In this case, the electronic apparatus 1500 may directly determine the fixed LIS, the serving wide beam of the fixed LIS, the position of the mobile LIS, and the serving wide beam of the mobile LIS. The information of the wide beam combination may also include index information, and the electronic apparatus 1500 searches in Table 1 for the fixed LIS, the serving wide beam of the fixed LIS, the position of the mobile LIS and the serving wide beam of the mobile LIS according to the index information.

According to the embodiments of the present disclosure, the electronic apparatus 1500 may also determine correspondence between candidate positions of the mobile LIS and beams according to the candidate region of the mobile LIS. That is, the mobile LIS scans only one wide beam at one candidate position. In other words, the candidate positions and wide beams of the mobile LIS are in one-to-one correspondence. In this way, multiple wide beam combinations configured by the electronic apparatus 1500 are as shown in Table 2 above. The combination (m, p, n) represents a case where the p-th fixed LIS uses the m-th wide beam and the mobile LIS uses the n-th wide beam. In this way, the user equipment can measure the channel quality of each wide beam of the mobile LIS and the wide beams of one or more candidate fixed LISs, and determine the fixed LIS, the serving wide beam of the fixed LIS and the serving wide beam of the mobile LIS according to measurement results.

According to the embodiments of the present disclosure, after the wide beam scanning, the electronic apparatus 1500 may receive information of the wide beam combination from the user equipment through the communication unit 1530. The information of the wide beam combination may include identification information of the fixed LIS, identification information of the serving wide beam of the fixed LIS and identification information of the serving wide beam of the mobile LIS. In this case, the electronic apparatus 1500 may directly determine the fixed LIS, the serving wide beam of the fixed LIS and the serving wide beam of the mobile LIS, and determine the position of the mobile LIS according to the correspondence between the serving wide beam of the mobile LIS and the position of the mobile LIS. The information of the wide beam combination may also include index information, and the electronic apparatus 1500 searches in the Table 2 for the fixed LIS, the serving wide beam of the fixed LIS and the serving wide beam of the mobile LIS according to the index information, and determines the position of mobile LIS according to the correspondence between the serving wide beam of the mobile LIS and the position of the mobile LIS.

According to the embodiments of the present disclosure, the electronic apparatus 1500 may configure a pre-coded/beam-formed reference signal, so that wide beams of different fixed LISs can be scanned at a same time period. That is, the electronic apparatus 1500 may configure multiple wide beam combination pairs, as shown in Table 3 above. The combination pair (m1, p1, n, q) (m2, p2, n, q) represents a case where the p1-th fixed LIS uses the m1-th wide beam and the p2-th fixed LIS uses the m2-th wide beam at the same time, and the mobile LIS is in the q-th candidate position and uses the n-th wide beam.

According to the embodiments of the present disclosure, after the wide beam scanning, the electronic apparatus 1500 may receive information of the wide beam combination pair from the user equipment through the communication unit 1530. The information of the wide beam combination pair may include information of two wide beam combinations each of which includes identification information of the fixed LIS, identification information of the serving wide beam of the fixed LIS, identification information of the position of the mobile LIS and identification information of the serving wide beam of the mobile LIS. The information of the wide beam combination may also include index information, and the electronic apparatus 1500 searches Table 3 for the information of the two wide beam combinations according to the index information. The electronic apparatus 1500 may select a wide beam combination for retransmission of the reference signal, so that the user equipment measures channel quality for the retransmitted signal and feeds back to the electronic apparatus 1500 whether the channel quality is greater than the predetermined threshold. In a case that the channel quality is greater than the predetermined threshold, the electronic apparatus 1500 determines the fixed LIS, the serving wide beam of the fixed LIS, the position of the mobile LIS and the serving wide beam of the mobile LIS according to the wide beam combination. In a case that the channel quality is not greater than the predetermined threshold, the electronic apparatus 1500 determines the fixed LIS, the serving wide beam of the fixed LIS, the position of the mobile LIS, and the serving wide beam of the mobile LIS according to another wide beam combination.

According to the embodiments of the present disclosure, in a case that the electronic apparatus 1500 configures the pre-coded/beam-formed reference signal, and positions and wide beams of the mobile LIS are in one-to-one correspondence, the multiple wide beam combination pairs configured by the electronic apparatus 1500 are as shown in Table 4 above. The combinations (m1, p1, n) (m2, p2, n) represents a case where the p1-th fixed LIS uses the m1-th wide beam and the p2-th fixed LIS uses the m2-th wide beam at the same time, and the mobile LIS uses the n-th wide beam.

According to the embodiments of the present disclosure, after the wide beam scanning, the electronic apparatus 1500 may receive the information of the wide beam combination pair from the user equipment through the communication unit 1530. The information of the wide beam combination pair may include the information of two wide beam combinations each of which includes the identification information of the fixed LIS, the identification information of the serving wide beam of the fixed LIS and the identification information of the serving wide beam of the mobile LIS. The information of the wide beam combination may also include the index information, and the electronic apparatus 1500 searches Table 4 for the information of two wide beam combinations according to the index information. The electronic apparatus 1500 may select a wide beam combination for retransmission of the reference signal, so that the user equipment measures the channel quality for the retransmitted signal and feeds back to the electronic apparatus 1500 whether the channel quality is greater than the predetermined threshold. In a case that the channel quality is greater than the predetermined threshold, the electronic apparatus 1500 determines the fixed LIS, the serving wide beam of the fixed LIS and the serving wide beam of the mobile LIS according to a wide beam combination. In a case that the channel quality is not greater than the predetermined threshold, the electronic apparatus 1500 determines the fixed LIS, the serving wide beam of the fixed LIS, and the serving wide beam of the mobile LIS according to another wide beam combination. In addition, the electronic apparatus 1500 may determine the position of the mobile LIS according to the correspondence between the serving wide beams of the mobile LIS and the positions of the mobile LIS.

According to the embodiments of the present disclosure, the electronic apparatus 1500 may configure a narrow beam scanning process after the wide beam scanning process is completed. For example, the electronic apparatus 1500 may control the mobile LIS to fly to the position determined in the wide beam scanning process, the reference signal configuration unit 1510 configures a reference signal, and the LIS configuration unit 1520 configures a direction of the mobile LIS and a direction of the fixed LIS, so that the user equipment measures channel quality of narrow beams in the serving wide beam of the mobile LIS and narrow each beam in the serving wide beam of the fixed LIS and determines the serving narrow beam of the fixed LIS and the serving narrow beam of the mobile LIS according to measurement results.

According to the embodiments of the present disclosure, the electronic apparatus 1500 may configure multiple narrow beam pairs, as shown in Table 5 above. The combination (x, p, y) represents a case that a p-th fixed LIS uses an x-th narrow beam in the serving wide beam, and the mobile LIS uses a y-th narrow beam in the serving wide beam.

According to the embodiments of the present disclosure, after the narrow beam scanning, the electronic apparatus 1500 may receive information of the narrow beam combination from the user equipment through the communication unit 1530. The information of the narrow beam combination may include identification information of the serving narrow beam of the fixed LIS and identification information of the serving narrow beam of the mobile LIS. In this case, the electronic apparatus 1500 can directly determine the serving narrow beam of the fixed LIS and the serving narrow beam of the mobile LIS. The information of the narrow beam combination may also include index information. The electronic apparatus 1500 may search Table 5 for the serving narrow beam of the fixed LIS and the serving narrow beam of the mobile LIS according to the index information.

According to the embodiments of the present disclosure, after receiving the information of the narrow beam combination, the LIS configuration unit 1520 may configure a direction of the fixed LIS and a direction of the mobile LIS to serve the user equipment by the serving narrow beam of the fixed LIS and the serving narrow beam of the mobile LIS. The present disclosure is applicable to downlink transmission, and therefore the electronic apparatus 1500 can transmit downlink information to the user equipment through the serving narrow beam of the fixed LIS and the serving narrow beam of the mobile LIS.

FIG. 17 is a flowchart showing signaling of a process of determining a serving beam of the fixed LIS and a serving beam of the mobile LIS according to an embodiment of the present disclosure. In FIG. 17, the gNB may be implemented by the electronic apparatus 1500, and the UE may be implemented by the electronic apparatus 600. In addition, the fixed LIS shown in FIG. 17 is a finally determined fixed LIS. As shown in FIG. 17, in step S1701, the UE determines candidate fixed LISs. In step S1702, the UE transmits information of the candidate fixed LISs to the gNB. In step S1703, the gNB determines a candidate region of the mobile LIS. In step S1704, the gNB transmits the candidate region of the mobile LIS or a position of the mobile LIS in the candidate region to the mobile LIS. In step S1705, the gNB transmits the candidate region of the mobile LIS to the UE. In step S1706, the LIS reaches the candidate region. In step S1707, the gNB configures a reference signal, a direction of the candidate fixed LISs, and a direction of the mobile LIS to perform wide beam scanning. In step S1708, the UE determines a fixed LIS, a serving wide beam of the fixed LIS and a serving wide beam of the mobile LIS according to measurement results of the wide beam scanning. In step S1709, the UE transmits information indicating the fixed LIS, the serving wide beam of the fixed LIS and the serving wide beam of the mobile LIS to the gNB. In step S1710, the gNB configures a reference signal, a direction of the fixed LIS, and a direction of the mobile LIS to perform narrow beam scanning. In step S1711, the UE determines a serving narrow beam of the fixed LIS and a serving narrow beam of the mobile LIS according to measurement results of the narrow beam scanning. In step S1712, the UE transmits information indicating the serving narrow beam of the fixed LIS and the serving narrow beam of the mobile LIS to the gNB. In step S1713, the gNB configures a direction of the selected fixed LIS and a direction of the mobile LIS to serve the UE by the serving narrow beam of the fixed LIS and the serving narrow beam of the mobile LIS.

It can be seen that according to the embodiments of the present disclosure, the electronic apparatus 1500 may configure the reference signal, the direction of the fixed LIS and the direction of the mobile LIS, so that the user equipment can select the fixed LIS, the serving beam of the fixed LIS and the serving beam of the mobile LIS according to channel quality of the beams of the mobile LIS and the beams of the fixed LIS, so as to jointly serve the user equipment by the fixed LIS and the mobile LIS. In addition, the electronic apparatus 1500 may configure the wide beam scanning process first, and then configure the narrow beam scanning process, so as to save the time spent on scanning. Further, the electronic apparatus 1500 may configure the pre-coded/beam-formed RS, so that the user equipment scan serving wide beams from different fixed LISs simultaneously, thereby further saving the time spent on scanning. In short, according to the embodiments of the present disclosure, advantages of the fixed LIS and the mobile LIS can be combined, thereby improving quality of the communication between the electronic apparatus 1500 and the user equipment.

### 4. Method Embodiments

Next, a wireless communication method performed by an electronic apparatus 600 as user equipment in a wireless communication system according to an embodiment of the present disclosure will be described in detail.

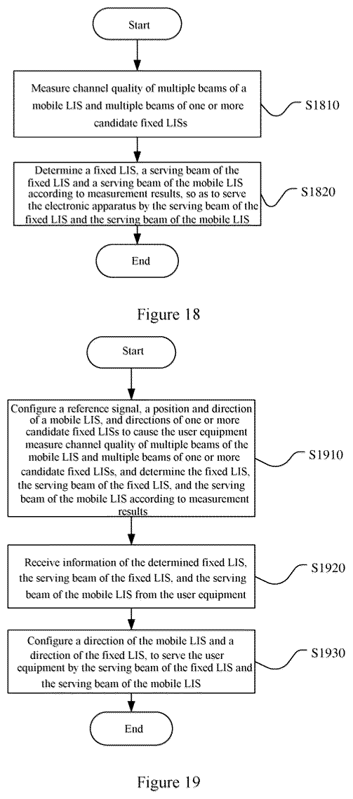

FIG. 18 is a flowchart of a wireless communication method performed by the electronic apparatus 600 as user equipment according to an embodiment of the present disclosure.

As shown in FIG. 18, in step S1810, channel quality of multiple beams of a mobile LIS and multiple beams of one or more candidate fixed LISs is measured.

Next, in step S1820, a fixed LIS, a serving beam of the fixed LIS and a serving beam of the mobile LIS are determined according to measurement results, so as to serve the electronic apparatus 600 by the serving beam of the fixed LIS and the serving beam of the mobile LIS.

Preferably, the wireless communication method further includes: determining one or more candidate fixed LISs; and transmitting the determined one or more candidate fixed LISs to a base station equipment.

Preferably, the determining one or more candidate fixed LISs includes: determining the one or more candidate fixed LISs according to positions or channel quality of all fixed LISs within serving range of the base station equipment.

Preferably, the determining one or more candidate fixed LISs according to positions of all fixed LISs within the serving range of the base station equipment includes: determining a candidate region of a fixed LIS according to transmission range of the base station equipment and reception range of the electronic apparatus 600; and determining fixed LISs in the candidate region of the fixed LIS as the candidate fixed LISs.

Preferably, the determining one or more candidate fixed LISs according to channel quality of all fixed LISs within the serving range of base station equipment includes: measuring channel quality of each beam of all fixed LISs; and determining a fixed LIS having a beam whose channel quality is greater than a predetermined threshold as the candidate fixed LISs.

Preferably, the determining one or more candidate fixed LISs includes: determining, in a case that the electronic apparatus is currently served by fixed LISs, the currently serving fixed LISs as the candidate fixed LISs.

Preferably, the determining the fixed LIS, the serving beam of the fixed LIS and the serving beam of the mobile LIS includes: measuring channel quality of each wide beam of the mobile LIS and each wide beam of the one or more candidate fixed LISs; and determining the fixed LIS, the serving wide beam of the fixed LIS and the serving wide beam of the mobile LIS according to measurement results, where the wide beam includes multiple beams.

Preferably, the wireless communication method further includes: transmitting information of the determined fixed LIS, serving wide beam of the fixed LIS and serving wide beam of the mobile LIS to the base station equipment, where the information includes identification information of the fixed LIS, identification information of the serving wide beam of the fixed LIS and identification information of the serving wide beam of the mobile LIS, or the information includes index information, where the index information has a correspondence with the fixed LIS, the serving wide beam of the fixed LIS and the serving wide beam of the mobile LIS.

Preferably, the determining the fixed LIS, the serving beam of the fixed LIS and the serving beam of the mobile LIS includes: measuring channel quality of each beam in the serving wide beam of the mobile LIS and each beam in the serving wide beam of the fixed LIS; and determine the serving beam of the fixed LIS and the serving beam of the mobile LIS according to measurement results.

Preferably, the wireless communication method further includes: transmitting information of the determined serving beam of the fixed LIS and the serving beam of the mobile LIS to the base station equipment, where the information includes identification information of the serving beam of the fixed LIS and identification information of the serving beam of the mobile LIS, or the information includes index information, where the index information has correspondence with the serving beam of the fixed LIS and the serving beam of the mobile LIS.

Preferably, the wireless communication method further includes: determining, in a case that channel quality of all currently available beams is lower than a predetermined threshold, to serve the electronic apparatus 600 by the fixed LIS and the mobile LIS.

Preferably, the wireless communication method further includes: transmitting information for requesting performing beam measurement to the base station equipment in a case that the channel quality of the currently serving beam is lower than the predetermined threshold; and measuring channel quality of all currently available beams according to a reference signal from the base station equipment.

According to the embodiments of the present disclosure, the method described above may be performed by the electronic apparatus 600 according to the embodiments of the present disclosure, and therefore all the previous embodiments of the electronic apparatus 600 are applicable to the method.

Next, a wireless communication method performed by the electronic apparatus 1500 as a network side equipment in a wireless communication system according to the embodiments of the present disclosure will be described in detail.

FIG. 19 is a flowchart of a wireless communication method performed by the electronic apparatus 1500 as a network side equipment in a wireless communication system according to an embodiment of the present disclosure.

As shown in FIG. 19, in step S1910, a reference signal, a position and direction of a mobile LIS, and directions of one or more candidate fixed LISs are configured, so that the user equipment measures channel quality of multiple beams of the mobile LIS and multiple beams of one or more candidate fixed LISs and determines the fixed LIS, the serving beam of the fixed LIS, and the serving beam of the mobile LIS according to measurement results.

Next, in step S1920, information of the determined fixed LIS, the serving beam of the fixed LIS, and the serving beam of the mobile LIS is received from the user equipment.

Next, in step S1930, a direction of the mobile LIS and a direction of the fixed LIS are configured, so that the user equipment is served by the serving beam of the fixed LIS and the serving beam of the mobile LIS.

Preferably, the wireless communication method further includes: receiving information of the one or more candidate fixed LISs from the user equipment.

Preferably, the wireless communication method further includes: determining a candidate region of the mobile LIS according to transmission range of the one or more candidate fixed LISs and reception range of the user equipment; and determining correspondence between positions and beams of the mobile LIS according to the candidate region of the mobile LIS.

Preferably, the determining the candidate region of the mobile LIS includes: determining an overlapping region between transmission range of each candidate fixed LIS and reception range of the user equipment; and determining the candidate region of the mobile LIS to include all overlapping regions.

Preferably, the wireless communication method further includes: configuring a reference signal, a position and direction of the mobile LIS, and directions of one or more candidate fixed LISs, so that the user equipment measures channel quality of each wide beam of the mobile LIS and each wide beam of the one or more candidate fixed LISs and determines the fixed LIS, a serving wide beam of the fixed LIS, and a serving wide beam of the mobile LIS according to measurement results; and receiving information of the determined fixed LIS, the serving wide beam of the fixed LIS and the serving wide beam of the mobile LIS from the user equipment, where the wide beam includes multiple beams.

Preferably, the information includes identification information of the fixed LIS, identification information of the serving wide beam of the fixed LIS and identification information of the serving wide beam of the mobile LIS. Alternatively, the information includes index information, which has correspondence with the fixed LIS, the serving wide beam of the fixed LIS and the serving wide beam of the mobile LIS.

Preferably, the wireless communication method further includes: configuring a reference signal, a position and direction of the mobile LIS, and a direction of the fixed LIS, so that the user equipment measures channel quality of each beam in the serving wide beam of the mobile LIS and each beam in the serving wide beam of the fixed LIS and determines the serving beam of the fixed LIS and the serving beam of the mobile LIS according to measurement results; and receiving information of the determined serving beam of the fixed LIS and the serving beam of the mobile LIS from the user equipment.

Preferably, the information includes identification information of the serving beam of the fixed LIS and identification information of the serving beam of the mobile LIS. Alternatively, the information includes index information, which has correspondence with the serving beam of the fixed LIS and the serving beam of the mobile LIS.

According to the embodiments of the present disclosure, the method described above may be performed by the electronic apparatus 1500 according to the embodiments of the present disclosure, and therefore all the previous embodiments of the electronic apparatus 1500 are applicable to the method.

### 5. Application Examples

The technology of the present disclosure is applicable to various products.

For example, the network side equipment may be implemented as any type of base station equipment, such as a macro eNB and a small eNB, and may be implemented as any type of gNB (a base station in a 5G system). The small eNB may be an eNB covering a cell smaller than a macro cell, such as a pico eNB, a micro eNB, or a home (femto) eNB. Alternatively, the base station may be implemented as any other type of base station, such as a NodeB and a base transceiver station (BTS). The base station may include a body (which is also referred to as a base station equipment) configured to control wireless communication and one or more remote radio heads (RRHs) that are arranged in a different place from the body.

The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as machine type communication (MTC) terminal). In addition, the user equipment may be a wireless communication module (such as an integrated circuit module including a single wafer) installed on each of the user equipment described above.

### Application Examples of Base Station

### First Application Example

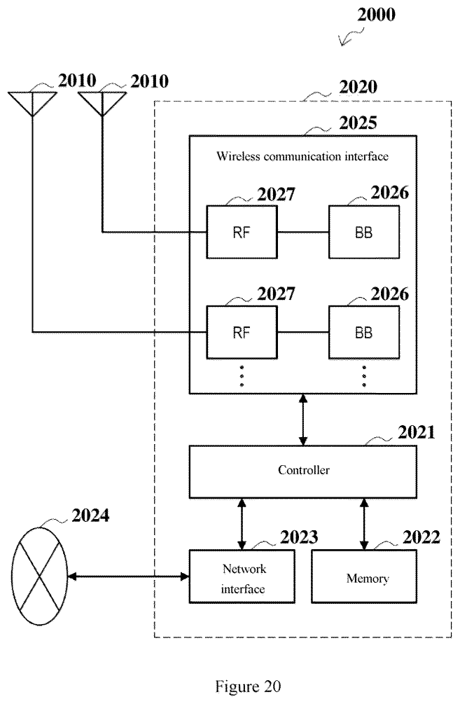

FIG. 20 is a block diagram showing a first example of a schematic configuration of an eNB to which the technology of the present disclosure may be applied. The eNB 2000 includes a single or multiple antennas 2010 and a base station equipment 2020. The base station equipment 2020 and each of the antennas 2010 may be connected with each other via an RF cable.

Each of the antennas 2010 includes a single or multiple antenna elements (such as multiple antenna elements included in a multiple-input multiple-output (MIMO) antenna), and is used for the base station equipment 2020 to transmit and receive wireless signals. The eNB 2000 may include multiple antennas 2010, as shown in FIG. 20. For example, the multiple antennas 2010 may be compatible with multiple frequency bands used by the eNB 2000. Although FIG. 20 shows an example in which the eNB 2000 includes multiple antennas 2010, the eNB 2000 may include a single antenna 2010.

The base station equipment 2020 includes a controller 2021, a memory 2022, a network interface 2023, and a wireless communication interface 2025.

The controller 2021 may be, for example, a CPU or a DSP, and operates various functions of a higher layer of the base station equipment 2020. For example, the controller 2021 generates a data packet based on data in a signal processed by the wireless communication interface 2025, and transfers the generated packet via the network interface 2023. The controller 2021 may bundle data from multiple baseband processors to generate a bundled packet, and transfer the generated bundled packet. The controller 2021 may have logical functions of performing control such as radio resource control, radio bearer control, mobility management, admission control, and scheduling. The control may be performed in conjunction with an adjacent eNB or a core network node. The memory 2022 includes an RAM and an ROM, and stores a program executed by the controller 2021, and various types of control data (such as a terminal list, transmission power data, and scheduling data).

The network interface 2023 is a communication interface for connecting the base station equipment 2020 to a core network 2024. The controller 2021 may communicate with a core network node or another eNB via the network interface 2023. In this case, the eNB 2000, and the core network node or the other eNB may be connected with each other through a logical interface (such as an SI interface and an X2 interface). The network interface 2023 may also be a wired communication interface or a wireless communication interface for a wireless backhaul line. In a case that the network interface 2023 is a wireless communication interface, the network interface 2023 may use a higher frequency band for wireless communication than a frequency band used by the wireless communication interface 2025.

The wireless communication interface 2025 supports any cellular communication scheme (such as Long Term Evolution (LTE) and LTE-Advanced), and provides wireless connection to a terminal positioned in a cell of the eNB 2000 via the antenna 2010. The wireless communication interface 2025 may typically include, for example, a baseband (BB) processor 2026 and a RF circuit 2027. The BB processor 2026 may perform, for example, encoding/decoding, modulating/demodulating and multiplexing/de-multiplexing, and perform various types of signal processes of layers (for example, LI, media access control (MAC), radio link control (RLC) and packet data convergence protocol (PDCP)). Instead of the controller 2021, the BB processor 2026 may have a part or all of the above logical functions. The BB processor 2026 may be a memory storing a communication control program, or a module including a processor and a related circuit configured to execute the program. Updating the program may change the functions of the BB processor 2026. The module may be a card or a blade inserted into a slot of the base station equipment 2020. Alternatively, the module may also be a chip mounted on the card or the blade. In addition, the RF circuit 2027 may include, for example, a frequency mixer, a filter and an amplifier, and transmit and receive wireless signals via the antenna 2010.

As shown in FIG. 20, the wireless communication interface 2025 may include multiple BB processors 2026. For example, the multiple BB processors 2026 may be compatible with multiple frequency bands used by the eNB 2000. As shown in FIG. 20, the wireless communication interface 2025 may include multiple RF circuits 2027. For example, the multiple RF circuits 2027 may be compatible with multiple antenna elements. Although FIG. 20 shows an example in which the wireless communication interface 2025 includes multiple BB processors 2026 and multiple RF circuits 2027, the wireless communication interface 2025 may include a single BB processor 2026 or a single RF circuit 2027.

### Second Application Example

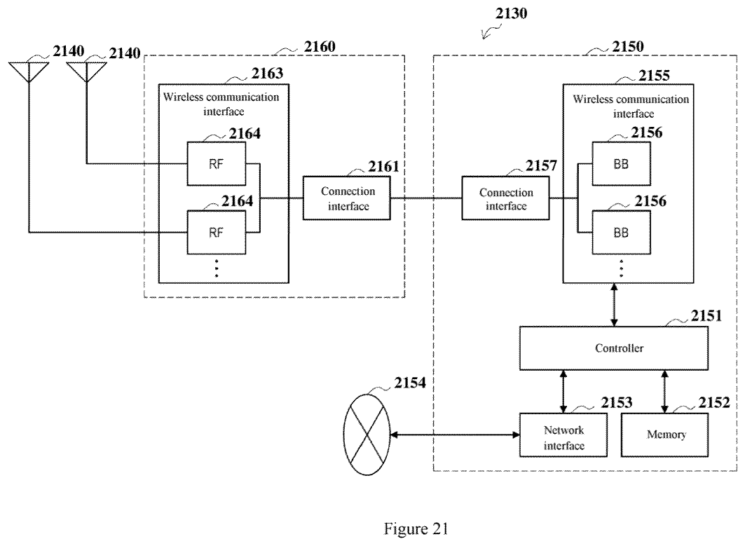

FIG. 21 is a block diagram showing a second example of a schematic configuration of an eNB to which the technology of the present disclosure may be applied. The eNB 2130 includes a single or multiple antennas 2140, a base station equipment 2150 and an RRH 2160. The RRH 2160 and each antenna 2140 may be connected with each other via an RF cable. The base station equipment 2150 and the RRH 2160 may be connected with each other via a high-speed line such as an optical fiber cable.

Each of the antennas 2140 includes a single or multiple antenna elements (such as multiple antenna elements included in an MIMO antenna), and is used for the RRH 2160 to transmit and receive wireless signals. As shown in FIG. 21, the eNB 2130 may include multiple antennas 2140. For example, the multiple antennas 2140 may be compatible with multiple frequency bands used by the eNB 2130. Although FIG. 21 shows an example in which the eNB 2130 includes multiple antennas 2140, the eNB 2130 may include a single antenna 2140.

The base station equipment 2150 includes a controller 2151, a memory 2152, a network interface 2153, a wireless communication interface 2155, and a connection interface 2157. The controller 2151, the memory 2152, and the network interface 2153 are the same as the controller 2021, the memory 2022, and the network interface 2023 described with reference to FIG. 20. The network interface 2153 is a communication interface used to connect the base station equipment 2150 to a core network 2154.

The wireless communication interface 2155 supports any cellular communication scheme (such as LTE and LTE-advanced), and provides wireless communication with a terminal located in a sector corresponding to the RRH 2160 via the RRH 2160 and the antenna 2140. The wireless communication interface 2155 may typically include, for example, a BB processor 2156. The BB processor 2156 is the same as the BB processor 2026 described with reference to FIG. 20, except that the BB processor 2156 is connected with a RF circuit 2164 of the RRH 2160 via the connection interface 2157. As shown in FIG. 21, the wireless communication interface 2155 may include multiple BB processors 2156. For example, the multiple BB processors 2156 may be compatible with multiple frequency bands used by the eNB 2130. Although FIG. 21 shows an example in which the wireless communication interface 2155 includes multiple BB processors 2156, the wireless communication interface 2155 may include a single BB processor 2156.

The connection interface 2157 is an interface for connecting the base station equipment 2150 (the wireless communication interface 2155) to the RRH 2160. The connection interface 2157 may also be a communication module for communication in the above high-speed line that connects the base station equipment 2150 (the wireless communication interface 2155) to the RRH 2160.

The RRH 2160 includes a connection interface 2161 and a wireless communication interface 1963.

The connection interface 2161 is an interface for connecting the RRH 2160 (the wireless communication interface 1963) to the base station equipment 2150. The connection interface 2161 may also be a communication module for communication in the above high-speed line.

The wireless communication interface 2163 transmits and receives wireless signals via the antenna 2140. The wireless communication interface 2163 may typically include, for example, the RF circuit 2164. The RF circuit 2164 may include, for example, a frequency mixer, a filter and an amplifier, and transmit and receive wireless signals via the antenna 2140. The wireless communication interface 2163 may include multiple RF circuits 2164, as shown in FIG. 21. For example, the multiple RF circuits 2164 may support multiple antenna elements. Although FIG. 21 shows an example in which the wireless communication interface 2163 includes multiple RF circuits 2164, the wireless communication interface 2163 may include a single RF circuit 2164.

In the eNB 2000 shown in FIG. 20 and the eNB 2130 shown in FIG. 21, the reference signal configuration unit 1510, the LIS configuration unit 1520, and the determination unit 1540 described in FIG. 15 may be implemented by the controller 2021 and/or the controller 2151. At least a part of the functions may be implemented by the controller 2021 and the controller 2151. For example, the controller 2021 and/or the controller 2151 may configure the reference signal, configure the direction of the fixed LIS, configure the position and direction of the mobile LIS, and determine the candidate region and serving time of the mobile LIS, by executing instructions stored in a corresponding memory.

### Application Examples of Terminal Device

### First Application Example

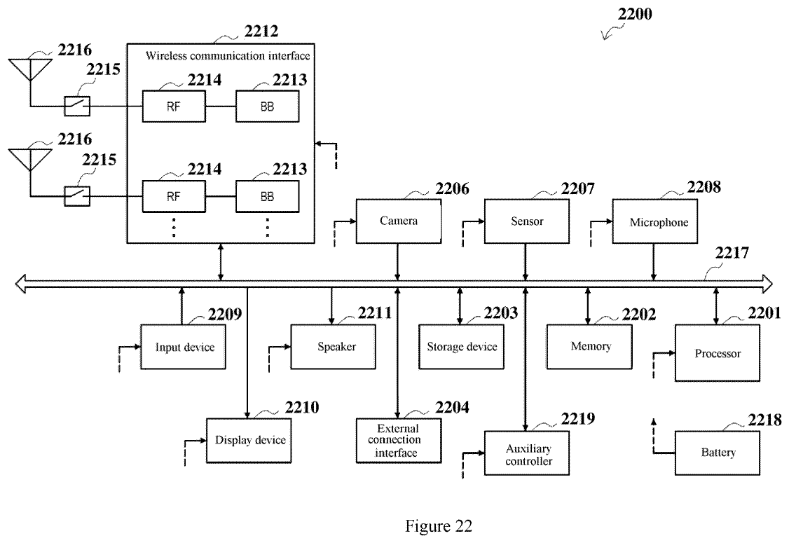

FIG. 22 is a block diagram showing an example of a schematic configuration of a smartphone 2200 to which the technology of the present disclosure may be applied. The smartphone 2200 includes a processor 2201, a memory 2202, a storage device 2203, an external connection interface 2204, a camera 2206, a sensor 2207, a microphone 2208, an input device 2209, a display device 2210, a speaker 2211, a wireless communication interface 2212, one or more antenna switches 2215, one or more antennas 2216, a bus 2217, a battery 2218 and an auxiliary controller 2219.

The processor 2201 may be, for example, a CPU or a system on chip (SoC), and control functions of an application layer and another layer of the smartphone 2200. The memory 2202 includes an RAM and an ROM, and stores a program that is executed by the processor 2201, and data. The storage device 2203 may include a storage medium such as a semiconductor memory and a hard disk. The external connection interface 2204 is an interface for connecting an external device (such as a memory card and a universal serial bus (USB) device) to the smartphone 2200.

The camera 2206 includes an image sensor (such as a charge coupled device (CCD) and a complementary metal oxide semiconductor (CMOS)) and generates a captured image. The sensor 2207 may include a group of sensors, such as a measurement sensor, a gyroscope sensor, a geomagnetic sensor and an acceleration sensor. The microphone 2208 converts sounds that are inputted to the smartphone 2200 into audio signals. The input device 2209 includes, for example, a touch sensor configured to detect touch on a screen of the display device 2210, a keypad, a keyboard, a button, or a switch, and receives an operation or information inputted from a user. The display device 2210 includes a screen (such as a liquid crystal display (LCD) and an organic light-emitting diode (OLED) display), and displays an output image of the smartphone 2200. The speaker 2211 converts audio signals that are outputted from the smartphone 2200 to sounds.

The wireless communication interface 2212 supports any cellular communication scheme (such as LTE and LTE-Advanced), and performs wireless communications. The wireless communication interface 2212 may typically include, for example, a BB processor 2213 and a RF circuit 2214. The BB processor 2213 may perform, for example, encoding/decoding, modulating/demodulating and multiplexing/de-multiplexing, and perform various types of signal processing for wireless communications. Meanwhile, the RF circuit 2214 may include, for example, a frequency mixer, a filter and an amplifier, and transmit and receive wireless signals via the antenna 2216. The wireless communication interface 2212 may be a chip module on which the BB processor 2213 and the RF circuit 2214 are integrated. As shown in FIG. 22, the wireless communication interface 2212 may include multiple BB processors 2213 and multiple RF circuits 2214. Although FIG. 22 shows an example in which the wireless communication interface 2212 includes multiple BB processors 2213 and multiple RF circuits 2214, the wireless communication interface 2212 may include a single BB processor 2213 or a single RF circuit 2214.

Furthermore, in addition to the cellular communication scheme, the wireless communication interface 2212 may support another type of wireless communication scheme such as a short-distance wireless communication scheme, a near field communication scheme, and a wireless local area network (LAN) scheme. In this case, the wireless communication interface 2212 may include a BB processor 2213 and a RF circuit 2214 for each wireless communication scheme.

Each of the antenna switches 2215 switches a connection destination of the antenna 2216 among multiple circuits (such as circuits for different wireless communication schemes) included in the wireless communication interface 2212.

Each of the antennas 2216 includes a single or multiple antenna elements (such as multiple antenna elements included in an MIMO antenna), and is used for the wireless communication interface 2212 to transmit and receive wireless signals. The smartphone 2200 may include multiple antennas 2216, as shown in FIG. 22. Although FIG. 22 shows an example in which the smartphone 2200 includes multiple antennas 2216, the smartphone 2200 may include a single antenna 2216.

Furthermore, the smartphone 2200 may include an antenna 2216 for each wireless communication scheme. In this case, the antenna switch 2215 may be omitted from the configuration of the smartphone 2200.

The processor 2201, the memory 2202, the storage device 2203, the external connection interface 2204, the camera 2206, the sensor 2207, the microphone 2208, the input device 2209, the display device 2210, the speaker 2211, the wireless communication interface 2212 and the auxiliary controller 2219 are connected with each other via the bus 2217. The battery 2218 supplies power to blocks in the smartphone 2200 shown in FIG. 22 via a feeder line which is indicated partially as a dashed line in FIG. 22. The auxiliary controller 2219 operates a minimum necessary function of the smartphone 2200 in a sleeping mode, for example.

In the smartphone 2200 shown in FIG. 22, the measurement unit 610, the determination unit 620, the determination unit 630, the generation unit 650, and the decision unit 660 described in FIG. 6 may be implemented by the processor 2201 or the auxiliary controller 2219. At least a part of the functions may be implemented by the processor 2201 or the auxiliary controller 2219. For example, the processor 2201 or the auxiliary controller 2219 may measure channel quality, determine the fixed LIS, determine the serving beam of the fixed LIS, determine the serving beam of the mobile LIS, determine the position of the mobile LIS, determine the candidate fixed LIS, generate information to be transmitted to the outside, and determine whether to serve the smartphone by the fixed LIS and the mobile LIS by executing instructions stored in the memory 2202 or the storage device 2203.

### Second Application Example

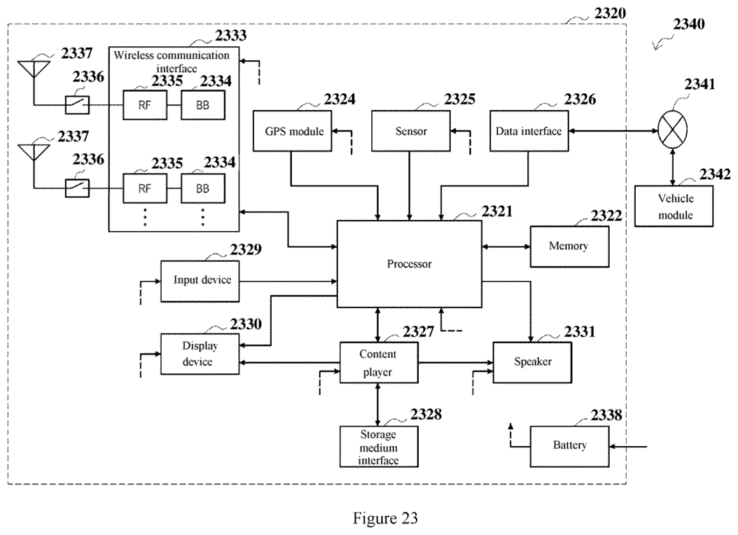

FIG. 23 is a block diagram showing an example of a schematic configuration of a car navigation device 2320 to which the technology of the present disclosure may be applied. The car navigation device 2320 includes a processor 2321, a memory 2322, a global positioning system (GPS) module 2324, a sensor 2325, a data interface 2326, a content player 2327, a storage medium interface 2328, an input device 2329, a display device 2330, a speaker 2331, a wireless communication interface 2333, one or more antenna switches 2336, one or more antennas 2337 and a battery 2338.

The processor 2321 may be, for example, a CPU or an SoC, and control a navigation function and another function of the car navigation device 2320. The memory 2322 includes an RAM and an ROM, and stores a program that is executed by the processor 2321, and data.

The GPS module 2324 measures a position (such as latitude, longitude and altitude) of the car navigation device 2320 based on a GPS signal received from a GPS satellite. The sensor 2325 may include a group of sensors such as a gyroscope sensor, a geomagnetic sensor, and an air pressure sensor. The data interface 2326 is connected with, for example, an in-vehicle network 2341 via a terminal not shown, and acquires data generated by the vehicle (such as vehicle speed data).

The content player 2327 reproduces content stored in a storage medium (such as a CD and a DVD) inserted into the storage medium interface 2328. The input device 2329 includes, for example, a touch sensor configured to detect touch on a screen of the display device 2330, a button, or a switch, and receives an operation or information inputted from a user. The display device 2330 includes a screen such as an LCD or an OLED display, and displays an image of the navigation function or content that is reproduced. The speaker 2331 outputs sound of the navigation function or the content that is reproduced.

The wireless communication interface 2333 supports any cellular communication scheme (such as LTE and LTE-Advanced), and performs wireless communications. The wireless communication interface 2333 may typically include, for example, a BB processor 2334 and a RF circuit 2335. The BB processor 2334 may perform, for example, encoding/decoding, modulating/demodulating and multiplexing/de-multiplexing, and perform various types of signal processing for wireless communications. Meanwhile, the RF circuit 2335 may include, for example, a frequency mixer, a filter and an amplifier, and transmit and receive wireless signals via the antenna 2337. The wireless communication interface 2333 may also be a chip module on which the BB processor 2334 and the RF circuit 2335 are integrated. As shown in FIG. 23, the wireless communication interface 2333 may include multiple BB processors 2334 and multiple RF circuits 2335. Although FIG. 23 shows an example in which the wireless communication interface 2333 includes multiple BB processors 2334 and multiple RF circuits 2335, the wireless communication interface 2333 may include a single BB processor 2334 or a single RF circuit 2335.

Furthermore, in addition to the cellular communication scheme, the wireless communication interface 2333 may support another type of wireless communication scheme such as a short-distance wireless communication scheme, a near field communication scheme, and a wireless LAN scheme. In this case, the wireless communication interface 2333 may include a BB processor 2334 and a RF circuit 2335 for each type of wireless communication scheme.

Each of the antenna switches 2336 re-determines a connection destination of the antenna 2337 among multiple circuits (such as circuits for different wireless communication schemes) included in the wireless communication interface 2333.

Each of the antennas 2337 includes a single or multiple antenna elements (such as multiple antenna elements included in an MIMO antenna), and is used for the wireless communication interface 2333 to transmit and receive wireless signals. The car navigation device 2320 may include multiple antennas 2337, as shown in FIG. 23. Although FIG. 23 shows an example in which the car navigation device 2320 includes multiple antennas 2337, the car navigation device 2320 may include a single antenna 2337.

In addition, the car navigation device 2320 may include an antenna 2337 for each type of wireless communication scheme. In this case, the antenna switch 2336 may be omitted from the configuration of the car navigation device 2320.

The battery 2338 supplies power to blocks in the car navigation device 2320 shown in FIG. 23 via a feeder line which is indicated partially as a dashed line in FIG. 23. The battery 2338 accumulates power supplied from the vehicle.

In the car navigation device 2320 shown in FIG. 23, the measurement unit 610, the determination unit 620, the determination unit 630, the generation unit 650, and the decision unit 660 described in FIG. 6 may be implemented by the processor 2321. At least a part of the functions may be implemented by the processor 2321. For example, the processor 2321 may measure channel quality, determine the fixed LIS, determine the serving beam of the fixed LIS, determine the serving beam of the mobile LIS, determine the position of the mobile LIS, determine the candidate fixed LIS, generate information to be transmitted to the outside, and determine whether to serve the car navigation device by the fixed LIS and the mobile LIS by executing instructions stored in the memory 2322.

The technology of the present disclosure may also be implemented as an in-vehicle system (or a vehicle) 2340 including one or more blocks of the car navigation device 2320, the in-vehicle network 2341 and a vehicle module 2342. The vehicle module 2342 generates vehicle data (such as vehicle speed, engine speed, and fault information), and outputs the generated data to the in-vehicle network 2341.

Preferred embodiments of the present disclosure have been described above with reference to the drawings. However, the present disclosure is not limited to the above examples. Those skilled in the art may make various changes and modifications within the scope of the appended claims, and it should be understood that such changes and modifications naturally fall within the technical scope of the present disclosure.

For example, a unit shown by a dotted line box in the functional block diagram in the drawings indicates that the functional unit is optional in the corresponding device, and the optional functional units may be combined appropriately to achieve desired functions.

For example, multiple functions implemented by one unit in the above embodiments may be implemented by separate devices. Alternatively, multiple functions implemented by respective units in the above embodiments may be implemented by separate devices, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

Embodiments of the present disclosure are described above in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic apparatus comprising:
at least one processor; and
at least one memory including computer program code, where the at least one memory and the computer program code are configured, with the at least one processor, to cause the electronic apparatus to at least:
measure channel quality of a plurality of beams of a mobile Large Intelligent Surface LIS and a plurality of beams of one or more candidate fixed LISs; and
determine a fixed LIS, a serving beam of the fixed LIS, and a serving beam of the mobile LIS according to measurement results, to serve the electronic apparatus by the serving beam of the fixed LIS and the serving beam of the mobile LIS.

2. The electronic apparatus according to claim 1, wherein the at least one memory and the computer program code are further configured, with the at least one processor, to cause the electronic apparatus to:
determine the one or more candidate fixed LISs; and
transmit the determined one or more candidate fixed LISs to a base station equipment.

3. The electronic apparatus according to claim 2, wherein the at least one memory and the computer program code are further configured, with the at least one processor, to cause the electronic apparatus to:
determine the one or more candidate fixed LISs according to positions or channel quality of all fixed LISs within serving range of the base station equipment.

4. The electronic apparatus according to claim 3, wherein the at least one memory and the computer program code are further configured, with the at least one processor, to cause the electronic apparatus to:
determine a candidate region of a fixed LIS according to transmission range of the base station equipment and reception range of the electronic apparatus; and
determine fixed LISs in the candidate region of the fixed LIS as the candidate fixed LISs.

5. The electronic apparatus according to claim 3, wherein the at least one memory and the computer program code are further configured, with the at least one processor, to cause the electronic apparatus to:
measure channel quality of each beam of all fixed LISs; and
determine, as the candidate fixed LISs, fixed LISs having beams with channel quality greater than a predetermined threshold.

6. The electronic apparatus according to claim 2, wherein the at least one memory and the computer program code are further configured, with the at least one processor, to cause the electronic apparatus to:
determine, in a case that the electronic apparatus is currently served by fixed LISs, the currently serving fixed LISs as the candidate fixed LISs.

7. The electronic apparatus according to claim 2, wherein the at least one memory and the computer program code are further configured, with the at least one processor, to cause the electronic apparatus to:
measure channel quality of each wide beam of the mobile LIS and each wide beam of the one or more candidate fixed LISs; and
determine the fixed LIS, the serving wide beam of the fixed LIS and the serving wide beam of the mobile LIS according to measurement results,
wherein the wide beam comprises a plurality of beams.

8. The electronic apparatus according to claim 7, wherein the at least one memory and the computer program code are further configured, with the at least one processor, to cause the electronic apparatus to:
transmit information of the determined fixed LIS, the serving wide beam of the fixed LIS and the serving wide beam of the mobile LIS to the base station equipment,
wherein the information comprises identification information of the fixed LIS, identification information of the serving wide beam of the fixed LIS and identification information of the serving wide beam of the mobile LIS, or the information comprises index information having correspondence with the fixed LIS, the serving wide beam of the fixed LIS and the serving wide beam of the mobile LIS.

9. The electronic apparatus according to claim 7, wherein the at least one memory and the computer program code are further configured, with the at least one processor, to cause the electronic apparatus to:
measure channel quality of each beam in the serving wide beam of the mobile LIS and each beam in the serving wide beam of the fixed LIS; and
determine the serving beam of the fixed LIS and the serving beam of the mobile LIS according to measurement results.

10. The electronic apparatus according to claim 9, wherein the at least one memory and the computer program code are further configured, with the at least one processor, to cause the electronic apparatus to:
transmit information of the determined serving beam of the fixed LIS and serving beam of the mobile LIS to the base station equipment,
wherein the information comprises identification information of the serving beam of the fixed LIS and identification information of the serving beam of the mobile LIS, or the information comprises index information having correspondence with the serving beam of the fixed LIS and the serving beam of the mobile LIS.

11. The electronic apparatus according to claim 1, wherein the at least one memory and the computer program code are further configured, with the at least one processor, to cause the electronic apparatus to:
determine to serve the electronic apparatus by the fixed LIS and the mobile LIS in a case that channel quality of each of all currently available beams is lower than a predetermined threshold.

12. The electronic apparatus according to claim 11, wherein the at least one memory and the computer program code are further configured, with the at least one processor, to cause the electronic apparatus to:
transmit information for requesting performing beam measurement to the base station equipment in a case that channel quality of the currently serving beam is lower than the predetermined threshold; and
measure the channel quality of the all currently available beams according to a reference signal from the base station equipment.

13. An electronic apparatus, comprising:
at least one processor; and
at least one memory including computer program code, where the at least one memory and the computer program code are configured, with the at least one processor, to cause the electronic apparatus to at least:
configure a reference signal, a position and direction of a mobile Large Intelligent Surface LIS, and directions of one or more candidate fixed LISs, so that user equipment measures channel quality of a plurality of beams of the mobile LIS and a plurality of beams of the one or more candidate fixed LISs and determines a fixed LIS, a serving beam of the fixed LIS, and a serving beam of the mobile LIS according to measurement results;
receive, from the user equipment, information of the determined fixed LIS, the serving beam of the fixed LIS, and the serving beam of the mobile LIS; and
configure a direction of the mobile LIS and a direction of the fixed LIS, to serve the user equipment by the serving beam of the fixed LIS and the serving beam of the mobile LIS.

14. The electronic apparatus according to claim 13, wherein the at least one memory and the computer program code are further configured, with the at least one processor, to cause the electronic apparatus to:
receive information of the one or more candidate fixed LISs from the user equipment.

15. The electronic apparatus according to claim 13, wherein the at least one memory and the computer program code are further configured, with the at least one processor, to cause the electronic apparatus to:
determine a candidate region of the mobile LIS according to transmission range of the one or more candidate fixed LISs and reception range of the user equipment; and
determine correspondence between positions and beams of the mobile LIS according to the candidate region of the mobile LIS.

16. The electronic apparatus according to claim 15, wherein the at least one memory and the computer program code are further configured, with the at least one processor, to cause the electronic apparatus to:
determine an overlapping region between transmission range of each of the candidate fixed LISs and the reception range of the user equipment; and
determine the candidate region of the mobile LIS to comprises all the overlapping regions.

17. The electronic apparatus according to claim 15, the at least one memory and the computer program code are further configured, with the at least one processor, to cause the electronic apparatus to:
configure a reference signal, a position and direction of the mobile LIS, and directions of the one or more candidate fixed LISs, so that the user equipment measures channel quality of each wide beam of the mobile LIS and each wide beam of the one or more candidate fixed LISs and determines the fixed LIS, a serving wide beam of the fixed LIS, and a serving wide beam of the mobile LIS according to measurement results; and
receive, from the user equipment, information of the determined fixed LIS, the serving wide beam of the fixed LIS and the serving wide beam of the mobile LIS,
wherein the wide beam comprises a plurality of beams.

18. The electronic apparatus according to claim 17, wherein the information comprises identification information of the fixed LIS, identification information of the serving wide beam of the fixed LIS and identification information of the serving wide beam of the mobile LIS, or the information comprises index information having correspondence with the fixed LIS, the serving wide beam of the fixed LIS and the serving wide beam of the mobile LIS.

19. The electronic apparatus according to claim 17, wherein the at least one memory and the computer program code are further configured, with the at least one processor, to cause the electronic apparatus to:
configure a reference signal, a position and direction of the mobile LIS, and a direction of the fixed LIS, so that the user equipment measures channel quality of each beam in the serving wide beam of the mobile LIS and each beam in the serving wide beam of the fixed LIS and determines the serving beam of the fixed LIS and the serving beam of the mobile LIS according to measurement results; and
receive, from the user equipment, information of the determined serving beam of the fixed LIS and the serving beam of the mobile LIS.

20. (canceled)

21. A wireless communication method performed by an electronic apparatus, comprising:
measuring channel quality of a plurality of beams of a mobile Large Intelligent Surface LIS and a plurality of beams of one or more candidate fixed LISs; and
determining a fixed LIS, a serving beam of the fixed LIS, and a serving beam of the mobile LIS according to measurement results, to serve the electronic apparatus by the serving beam of the fixed LIS and the serving beam of the mobile LIS.

22-41. (canceled)
